(19) United States
(12) Patent Application Publication
(10) Pub. No.: US 2005/0222922 A1
(43) Pub. Date: Oct. 6, 2005

(54) Method for calculating IBNP health reserves with low variance

(76) Inventor: Robert G. Lynch, Monona, WI (US)

Correspondence Address: BROOKS KUSHMAN P.C., 1000 TOWN CENTER, TWENTY-SECOND FLOOR, SOUTHFIELD, MI, 48075, US

(21) Appl. No.: 10/803,651

(22) Filed: Mar. 18, 2004

(51) Int. Cl. G06F 17/60

(52) U.S. Cl. 705/30

(57) ABSTRACT

The present invention is a method and system for estimating liability reserve amounts for incurred but not yet paid (EBNP) insurance claims by means of projecting paid claims (either gross or per exposure) by lag time based on adjusted average monthly paid amounts in historical data. Two versions of this method are disclosed, one which assumes that future paid claim amounts are independent of claims incurred and already paid, and the other which assumes that future paid claims are correlated with cumulative incurred and paid claims through the valuation date. Both versions have been shown to give significantly more accurate results than the traditional Completion Factor and Incurred claims Methods when applied to sets of real data.

### BACKGROUND OF THE INVENTION

1. Field of the Invention

The present invention is related to methods of calculating incurred but not yet paid insurance claim amounts.

2. Background Art

Liability reserve amount for incurred but not yet paid (IBNP) insurance claims, is a principal driver of reported financial results of insurers. Accurate estimates of IBNP liability reserve amount is required by a company to minimize reserve errors, reduce capital expenditures, accurately assess profitability and tax liabilities, maintain statutorily required minimum liability reserve amounts, comply with generally accepted accounting procedures (GAAP) and statutory reporting requirements in financial statements and the like. This is particularly true for health insurance and managed care organizations, though it is also applicable to other fields such as accident, life and disability insurance.

IBNP liability reserve amount. Using health insurance by way of example, a claim against an insurance company is incurred when a patient receives medical services from a health care provider. The provider then submits a claim for payment for those services to an insurance company. All or a portion of the claim will be paid by the insurance company at some time after the claim was incurred. That is, a claim lag time exists during which such things as claims reporting and processing occurs. For this reason, the actual amount of IBNP claims is unknown on any particular valuation date. The liability reserve amount is an estimated amount of incurred but not yet paid claims as of a valuation date for which the company is liable for payment.

An IBNP liability reserve amount is typically first estimated by a company's actuaries as a liability which is then recognized by the company's accountants as a reserve. IBNP liability reserves are quantities of money which, while they may reflect a cash amount represented as an asset in the possession and control of the insurance company, are actually monies that belong to someone else or that are contractually committed to pay for a third party's expenses, e.g. those of the health care service provider.

Accurate estimation of the IBNP liability reserve amount is very important. The variance between the actual amount of IBNP claims a company will eventually pay and the estimate for the IBNP liability reserve amount can be quite significant since the IBNP liability reserve amount at a given point in time can easily be greater than the total annual target profit for the company. Thus, even small inaccuracies in the estimations for IBNP liability reserve amounts can have a significant financial impact on the company.

Consequences of over-estimation of IBNP liability reserve amount. Since the IBNP liability reserve amount comes straight off a company's bottom line on its financial statement, over-estimating IBNP liability reserve amount causes the company to appear less profitable than it actually is. As a result, the company pays less income taxes than it would if the IBNP liability amount was actually known. This may result in an assessment of substantial penalties and interest by the Internal Revenue Service (IRS) for underpayment of taxes.

Under-reporting profitability may also adversely affect the stock prices for publicly traded companies, affective capitalization and capital-raising efforts. In addition, it may significantly effect executive's bonus arrangements, not to mention job security. Bonuses for rank-and-file employees can also be directly affected.

Over-estimation of the IBNP liability reserve amount means that too much money is set aside by the company in the reserve. This may directly affect the ability of the company's managers to take corporate actions, since certain statutory surplus levels are required for regulatory approval by state insurance commissioners of many actions such as acquiring a new block of business or launching a new line of business.

In response to unrealistic IBNP liability reserve estimates, auditors may recommend a restatement of the financials for the company which reflects badly on the company's Chief Financial Officer's (CFO's) performance, or they may return a qualified audit which reflects badly on the entire company in addition to its CFO.

Consequences of under-estimation of IBNP liability reserve amount. State insurance departments set required statutory surplus levels. Under-estimation of IBNP liability reserve amount means lower reserves, which means more surplus (surplus being cash in excess of recognized reserves). If a company is operating close to minimum “regulatory action” levels for surplus, and the Insurance regulators find that the IBNP liability reserves are inadequate, they may take actions against the company.

Under-estimating IBNP liability reserve amount causes the company to appear more profitable than it actually is. This may result in the inappropriate payment of performance-based bonuses to executives.

Finally, the rating of companies (e.g., Standard & Poor's, Best) is very sensitive to the surplus position. In addition to the “static” surplus position, a history of large variances in realized results from initially stated results will result in a lower rating for an otherwise equivalent surplus position. This has a direct effect on capitalization for for-profit companies (lower rating means higher interest paid for new bond issuance, lower stock values, etc.) as well as an indirect effect on marketing (people like to buy insurance from companies with strong ratings).

Current methods for estimating IBNP liability reserve amounts are inadequate. For the reasons just discussed, it is very important to Chief Financial Officers (CFOs) of managed care and health insurance organizations to minimize the month-to-month variation and inaccuracy in estimated liability reserves for IBNP. While a certain degree of real variation in these liability reserves is to be expected, it is the duty of the financial actuary to calculate as accurately as possible the amount to be expected. The achievement of this goal necessitates an understanding of the difference between the “process variance,” measured by the standard deviation of the underlying claim incurred and payment process, and the “method variance,” or standard error, which is a characteristic of the measurement method.

Due to the heuristic nature of most of the calculation methods used by actuaries, a certain amount of method variance is to be expected. However, a critical evaluation of the most common methods for estimating IBNP reserves used by actuaries practicing in health care finance, shows that these methods are based on faulty assumptions and so yield, for the most part, a much higher error due to methodology than is necessary.

A re-examination of one of the basic properties of variance will reveal why the usual IBNP liability reserve calculation methods result in a high method variance, and what will lower that variance. That key property is that statistical variances are additive under addition, but increase polynomially under multiplication. That is, the variance of the sum of a collection of random variables is, in general, the sum of the variances of the individual variables, while multiplication of random variables increases variance in proportion to the square of the multiplying factor. For ease of presentation here, let us assume that statistical co-variances are negligible.

So, to keep the method variance (standard error) to a minimum, one should seek to use methods that rely on the summation of data, and avoid methods that use or result in multiplicative factors. A prime example of this principle in statistics is the “Best (i.e., lowest variance) Linear Unbiased Estimator” of regression, which is derived by minimizing the sum of the squared errors.

It is worthwhile also scrutinizing the sources of variability in the process of claims incurred and payment (i.e., process variance) to better understand what one is attempting to measure. People get sick, more-or-less at random, and, if they judge themselves to be sufficiently sick, seek out medical care by going to their doctor or, in some cases, the hospital emergency room. At that point they enter the health care system, which provides them a selection of services or products that, hopefully, gets them well and back into their normal, healthy routine again. The amount and cost of this health care treatment can vary enormously in each case, depending on the presenting condition.

On the face of it, then, the actuary is concerned with dealing with these two largely random events: who gets sick how often, and how much does it cost?

However, between the point when the person (now a patient) enters the health care system, and the time when the paying party (e.g., the health insurer or HMO) actually cuts a check to the providers in the system to reimburse them for the expense of their services, a lot of things happen. And those things (let's call them “claims reporting and processing”) usually take time (the “claim lag”). During the claim lag time, the value of those healthcare services (or at least the part for which the payer is liable) floats in the limbo of IBNP.

The problem from the actuary's point of view is that the amount of time involved in claims reporting and processing can vary considerably in a seemingly random manner, and may or may not relate to how many claims are floating around in the IBNP limbo, or how big they are.

Completion Factor Method. The method used by most actuaries to address this problem and to calculate IBNP liability reserve amount is the Completion Factor Method, which is mathematically equivalent to the “Chain Ladder” and “Lag” methods. (see, Bluhm, W. F., et al., eds., Group Insurance, 4^{th} ed., pp. 811-828, 2003, Actex Publishing; Litow, M. E., 1989, A modified development method for deriving health claim reserves, Transactions of the Society of Actuaries, Volume 41:89-146, 1989). This method relies on the principle assumption that the only source of variability in actual claims liabilities is in the frequency and intensity of health care services (morbidity), and there is no variability in the rate of claims reporting and processing. That is, incurred claims will be reported to and paid by the health insurance payer at a constant rate over time with no process variance from this source. The Completion Factor Method is based on the calculation of the historical proportion of claims incurred in a given incurred period (usually the incurred month) and paid in that and any given succeeding period (usually the paid month), to the total incurred claims in the incurred period. This ratio is the “completion factor”. For a recent month, the incurred and paid claims are then multiplied by the reciprocal of the completion factor to give an estimate of the actual incurred claims in the incurred period. The total incurred claims are estimated by simply adding together the amounts calculated for each month up to the valuation date.

Since this process involves multiplying real data by a statistical parameter that is calculated using multiplication, it is no surprise that the standard error of the result is quite high. The fact that the Completion Factor Method suffers from a large method variance has been widely recognized. This method variance or error is sometimes described as a “low credibility”, and is especially problematic in months immediately preceding the valuation date, where lies the bulk of IBNP claim liability reserve amounts. Despite the high method variance associated with the Completion Factor Method, it remains the favored method by most actuaries. (Bluhm, W. F., et al., eds., Group Insurance, 4^{th} ed., pp. 811-828, 2003, Actex Publishing).

Incurred claims Method. Because of the high method variance of the Completion Factor Method, a second method is frequently applied called the “Incurred claims” method (also known as the “Exposure” or “Loss Ratio” methods). Under the Incurred claims Method, average amounts of incurred and paid claims from months well before the valuation date are “completed” (usually using the Completion Factor Method) to yield estimates of incurred claim amounts. Those monthly incurred claim estimates are then used to project total incurred claims for more recent months. The IBNP liability reserve amount is then determined as the difference between the incurred and paid claims, and the incurred claim amounts estimated in this manner.

The Incurred claims Method suffers from the obvious shortcoming that, for purposes of estimating incurred claims, it totally ignores the amounts for claims incurred and already paid for the claims incurred periods to which it is applied. This results in a negative correlation between claims already paid and claims not yet paid for any given month of incurred, which is totally the opposite relation from that assumed by the Completion Factor Method.

Furthermore, if the Incurred claims Method is applied to claim incurred periods with more than a minimal claims payment runout period, the amount of claims already paid for a month may exceed the projected total incurred claim amount. Since negative IBNP liability reserve amounts are, in general, not allowed, this situation results in an inherent bias in the Incurred claims Method towards over-estimation of incurred claims and IBNP liability reserve amounts. The Incurred claims Method and its variations have also been extensively discussed in the literature (see e.g., Bluhm, W. F., et al., eds., Group Insurance, 4^{th} ed., pp. 811-828, 2003, Actex Publishing).

As with the Completion Factor Method, the Incurred claims Method for calculating IBNP claim liability reserve amount is based on a false assumption. That is, that the only source of variability in how much is paid in claims each month is due to the claims reporting and processing, and there is no variability in actual member morbidity.

In conclusion, the two main methodologies currently employed for calculating IBNP liability reserve amount yield inaccurate results due to relatively high method variances inherent in the methodologies. Despite their obvious shortcomings however, the prevalence of these two methods is such that they are specified by the National Association of Insurance commissioners (NAIC) as the methods of choice for calculation of claim liability reserves (NAIC, NAIC Health Reserves Guidance Manual. 2001).

For the foregoing reasons, there is a need for a new system and method for accurately estimating liability reserve amounts for incurred but not yet paid (IBNP) insurance claims, for use by an insurance company in accurately estimating IBNP claim liability reserve amount so as to minimize liability reserve errors, reduce capital expenditures, accurately assess profitability and tax liabilities, maintain statutorily required minimum reserve amounts, comply with GAAP and statutory reporting requirements in financial statements and the like.

### SUMMARY OF THE INVENTION

The present invention is directed to a system and method that satisfies this need for accurately estimating liability reserve amount for incurred but not yet paid (IBNP) insurance claims for use by an insurance company so as to minimize liability reserve errors, reduce capital expenditures, accurately assess profitability and tax liabilities, maintain statutorily required minimum reserve amounts, comply with GAAP and statutory reporting requirements in financial statements and the like. The computer-implemented method of the present invention is directed to providing estimations of IBNP liability reserve amounts that will vary minimally from the actual IBNP amounts eventually paid by a company.

In one embodiment the present invention provides a method for estimating incurred but not yet paid (IBNP) claim amounts suitable for execution on a computer system. The method comprises accessing a set of historical data for each of a plurality of incurred periods and paid periods prior to a valuation date. An incurred period is a time period in which a claim is incurred while a paid period is a time period in which the incurred claim is paid. Moreover the set of historical data comprises a paid lag claim amount for each combination of incurred and paid periods where the paid lag claim amount is the total actual amount of claims incurred in a given incurred period and paid a given lag time later in a given paid period. The lag time is a measure of elapsed time from a point in the given incurred period to the given paid period. The method of the present invention further comprises identifying a functional relationship between cumulative paid lag claim amounts and paid lag claim amounts. This function relationship will have one or more adjustable parameters with the cumulative paid lag claim amounts are independent variables and the paid claim amounts are dependent variables. The cumulative paid lag claim amount for a selected incurred period is the sum of paid lag claim amounts for one or more paid periods or the sum of paid lag claim amounts for one or more paid periods multiplied by a weighting factor (as of the valuation date). Next, in accordance with the method of the invention, the one or more adjustable parameters are adjusted to obtain optimized parameters such that a predetermined function of differences between calculated paid lag claim amounts and actual paid lag claim amounts is minimized (e.g., a least squares regression). The functional relationship with the optimized parameters is used to estimate IBNP claim amounts for each combination of incurred periods and paid periods after the valuation date for each paid period after the valuation date, from the cumulative paid lag claim amounts for each incurred period as of the valuation date. In one variation of the invention, the IBNP claim amounts may then be used to calculate an incurred period IBNP claim amount for each incurred period by summing the IBNP claim amounts estimated over all paid periods after the valuation date for each incurred period before the valuation date. The incurred period IBNP claim amounts may be used to estimate a total IBNP liability reserve amount as of the valuation date by summing the incurred period IBNP claim amounts over all incurred periods prior to the valuation date. In another variation of this embodiment, a paid period IBNP claim amount for each paid period after the valuation date is calculated by summing IBNP claim amounts over all incurred periods before the valuation date for each paid period after the valuation date. The paid period IBNP claim amount may then be used to estimate a total IBNP liability reserve amount by summing the paid period IBNP claim amounts over all paid periods after the valuation date.

In still another variation of this embodiment, each of the plurality of incurred periods has an associated number of exposures. Moreover, the weighting factor multiplying the paid lag claim amounts (before summing) for each of the plurality of incurred periods is 1 divided by the associated number of exposures. This produces a per exposure paid lag claim amounts where the cumulative paid lag claim amounts are the per exposure cumulative paid lag claim amounts and the IBNP claim amounts are the per exposure IBNP claim amounts. An incurred period IBNP claim amount for each incurred period is calculated by summing, over all paid periods after the valuation date, the products of the per exposure IBNP claim amount for the given paid period times the number of exposures for that incurred period. The incurred period IBNP may then be used to estimate a total IBNP liability reserve amount by summing the incurred period IBNP claim amount over all incurred periods. Alternatively, a paid period IBNP claim amount for each paid period after the valuation date may be calculated by summing, over all incurred periods before the valuation date for the respective paid periods, the products of the per exposure IBNP claim amount for the given paid period times the number of exposures for the respective incurred periods. The paid period IBNP claim amounts may be used to estimate a total IBNP liability reserve amount by summing the paid period IBNP claim amounts over all paid periods.

In another embodiment of the present invention, an alternative method for estimating incurred but not yet paid (IBNP) claim amounts is provided. The method of this embodiment comprises accessing a set of historical data for each of a plurality of incurred periods and paid periods prior to a valuation date. Again, an incurred period being a time period in which a claim is incurred and a paid period being a time period in which the incurred claim is paid. The set of historical data comprising a paid lag claim amount for each combination of incurred and paid periods where the paid lag claim amount is a total actual amount of claims incurred in a given incurred period and paid a given lag time later in a given paid period and the lag time is a measure of elapsed time from a point in the given incurred period to the given paid period. A summed paid lag claim amount for a selected lag time that is equal to the sum of paid lag claim amounts for incurred periods times an incurred month specific weighting factor as of the valuation date for the selected lag time is then calculated. The incurred month specific weighting factor is set to a predetermined value for each incurred month. Next, a summed exposure amount that is the sum of exposures for each incurred period times the incurred month specific weighting factor that is used to calculate the summed paid lag claim amount is calculated. Finally, a weighted average per exposure IBNP claim amount for each lag time is estimated by dividing the summed paid lag claim amount by the summed exposure amount. IBNP claim amounts may then be used to estimate an incurred period IBNP claim amount for each incurred period by summing IBNP claim amounts over all paid periods after the valuation date for each incurred period before the valuation date. It will be readily recognized that when the incurred month specific weighting factor is equal to one, the IBNP claim amounts are average per exposure paid lag claim amount. Moreover, in a variation of this embodiment, a total IBNP liability reserve amount is estimated by summing the incurred period IBNP claim amount over all incurred periods.

In yet another embodiment of the present invention, a computer system having memory for accessibly storing data (e.g., a database) and a processor for processing data are provided. The computer system of this embodiment executes the method of the invention set forth above. A set of historical data for each of a plurality of time periods prior to a valuation date is stored in the memory. This historical data may consist of a number of exposures, and a paid lag claim amount for each combination of incurred and paid periods.

An average paid lag claim amount is calculated for each lag time, by summing the paid lag claim amounts for a given lag time over all incurred periods for which the time from the end of the incurred period to the valuation date is greater than or equal to the lag time, and dividing the resulting sum by the total number of incurred periods. Calculating the average may optionally involve applying a user-defined weighting factor to the paid lag claim amounts. IBNP claim lag amount are projected by setting the IBNP claim amount for claims incurred in a given incurred period before the valuation date and to be paid a given lag time later in a given paid period following the valuation date equal to the average paid lag claim amount for the given lag time. A total IBNP claim amount for each incurred period is estimated by summing the projected IBNP claim amounts over all paid periods after the valuation date for a given incurred period. The total liability reserve amount for IBNP claims on the valuation date is estimated by summing the total IBNP claim amount for each incurred period over all incurred periods. A user of the computer-implemented method is then able to use these estimated IBNP claim amounts to minimize liability reserve errors, maintain statutorily required minimum IBNP reserve amounts and to more accurately comply with GAAP and statutory reporting requirements in financial statements.

In a variation of this embodiment, the computing system implements a method in which a cumulative paid lag claim amount as of the valuation date is calculated by summing the paid lag claim amounts over all incurred and paid periods prior to the valuation date. The calculated average paid lag claim amount for each lag time may be further improved by statistically regressing the paid lag claim amount against the cumulative paid lag claim amount to calculate a regressed paid lag claim amount for each lag time. Such regression typically involves identifying a functional relationship between cumulative paid lag claim amounts and paid lag claim amounts as set forth above. The above calculations am also be expressed in terms of per-exposure units.

In another aspect, a program storage device, readable by a machine, tangibly embodying a program of instructions executable by the machine is provided to perform one or more of the processes described above.

In another aspect, an article having a computer-usable medium has computer-readable program code embodied in the medium for performing one or more of the processes described above.

In another aspect, a computer program product is provided to perform one or more of the processes described above.

In any of the embodiment or variations of the method and computer system of the invention, adjustments to the paid lag claim amounts may be made for seasonality effects and trends. If this is done, the projected IBNP claim amounts may also be adjusted for effects of trend or seasonality.

Several objects and advantages of the present invention include providing (a) means by which IBNP claim amounts for claims incurred in a given incurred period before a valuation date and to be paid a given lag time later in a given paid period following the valuation date, are projected be setting same equal to the average paid lag claim amount for the given lag time; (b) means by which total liability reserve amount for IBNP claims may be accurately estimated with minimal variance from the actual IBNP amount eventually paid by a payer; and (c) means for outputting the IBNP claim amount estimates for use to minimize liability reserve error with the resulting advantages of reduction of capital expenditures, accurate assessment of profitability and tax liabilities, maintenance of statutorily required minimum reserve amounts, compliance with GAAP and statutory reporting requirements in financial statements, and the like.

The reader is advised that this summary is not meant to be exhaustive. Further features, aspects, and advantages of the present invention will become better understood with reference to the following description, accompanying drawings and appended claims.

### BRIEF DESCRIPTION OF DRAWINGS

For a better understanding of the present invention, reference may be made to the accompanying drawings, in which:

FIG. 1, shows an overview of the method steps of versions of the present invention;

FIG. 2, shows the general system of the present invention; and,

FIG. 3, shows the projected paid lag module of the general system of the present invention.

### DETAILED DESCRIPTION OF THE PREFERRED EMBODIMENT(S)

Referring now specifically to the figures, in which identical or similar parts are designated by the same reference numerals throughout, a detailed description of the present invention is given. It should be understood that the following detailed description relates to the best presently known embodiment of the invention. However, the present invention can assume numerous other embodiments, as will become apparent to those skilled in the art, without departing from the appended claims. For example, the present invention may be applied to other areas of insurance.

It should also be understood that, while the methods disclosed herein may be described and shown with reference to particular steps performed in a particular order, these steps may be combined, sub-divided, or re-ordered to form an equivalent method without departing from the teachings of the present invention. Accordingly, unless specifically indicated herein, the order and grouping of the steps is not a limitation of the present invention.

### Definitions

Claim—A claim is an amount of charges for health care services for which a payer (e.g., an insurance carrier) is liable for payment.

Claims: Incurred Period—An incurred period is a time period in which a claim is incurred.

Claims: Lag Time—A lag time is a measure of elapsed time from claim incurral to claim payment. Lag time is measured from a point in the claim incurred period to an equivalent point in the claim paid period (e.g., from the start of the claim incurred period to the start of the claim paid period; from the end of the claim incurred period to the end of the claim paid period; or the like).

Claims: Paid Period—A paid period is a time period in which the claim is paid.

Claims: Completed claims—Completed claims is an estimate of an amount of incurred claims arrived at by adding the incurred but not yet paid (IBNP) claims estimate and the incurred and paid claim amount.

Claims: Incurred claims—An incurred claim amount is an actual amount of claims incurred in a given incurred period, regardless of when the claims are actually paid. The incurred claim amount is not known for certain until long after a claim event (i.e., when all the incurred claims have been paid), but it is what the user of the present invention is attempting to estimate.

Claims: Incurred and Paid claims—An incurred and paid claim amount is an amount of claims incurred in a given incurred period, and paid in a given paid period.

Claims: Paid claims—A paid claim amount is an amount of claims paid by a payer within a given paid period, regardless of when the claims were incurred. Similar to incurred and paid claims, there may or may not be a run-in period associated with paid claims, depending on the situation.

Claims: Per Exposure Paid Lag claims—A per exposure paid lag claim amount is the total incurred and paid claim amount divided by the number of exposures in the incurred period over all incurred and paid periods.

Claims: Paid Lag claim Amount—A paid lag claim amount is a total actual amount of claims incurred in a given incurred period and paid a given lag time later in a given paid period. The paid lag claim amount is the incurred and paid claim amount organized by incurred period and lag time. There is a paid lag claim amount for each combination of incurred and paid period.

Claims: Reported claims—Reported claims are claims for which the payer has received a request for payment from a provider or covered member, but which have not yet been paid by the payer. Historically, the period of time for claims to be reported was considerable longer than the amount of time it took a payer to process and pay the claim once it was reported. For this reason, insurers frequently tracked Incurred but not yet reported (IBNR) claim liability reserves rather than IBNP reserves. The prevalence of the IBNR terminology is such that insurance company personnel frequently refer to “IBNR” claim reserves when they are actually referring to IBNP claim reserves. The difference between an IBNR reserve and an IBNP reserve lies solely in the establishment of the point in the claim “life cycle” when the liability is actually measured. The methods used to determine IBNR claim liability reserves and IBNP claim liability reserves are identical. For purposes of this patent, reported claims are considered paid claims so long as the application of terms is consistent.

Completion Factor Method—The Completion Factor method is a method traditionally used for estimating IBNP liability reserve amount that takes into account variance in claims incurred, but not in claims reporting, processing and payment. In so doing, the Completion Factor Method contains the implicit assumption that the rate of claims reporting, processing and payment is constant and does not vary with time. (see Overview—theoretical background section for further explanation).

Contract unit—In health insurance, the contract unit is the entity for which coverage is provided. The exact definition will depend on the definition given or implied within the specific contract of insurance coverage. Typically, the contract unit is considered to be either an individual member or a subscriber plus any covered dependents. Thus, the contract unit may variously include single individuals, a subscriber and spouse, a subscriber and dependent children, or a full family unit (subscriber, spouse and dependent children.) Contract units are sometimes referred to as simply “contracts”.

Dependent variable—In a mathematical expression relating two or more variables, the dependent variable is the “output” variable, which takes on a characteristic value depending on the chosen value of the “input”, or independent variable (or variables). When such mathematical relationships are displayed graphically using Cartesian coordinates, the dependent variable is typically identified as the vertical, or “y” axis. In functional representations of relationships, the dependent variable is expressed as a function of the independent variable. For example, in the expression y=f(x), x represents the independent variable, and y represents the dependent variable which takes on a unique value for each value of x for which the function f is valid. The term dependent variable should not be confused with the concept of dependence or independence of variables.

Exposure—A measure of the amount of risk assumed by a payer of insurance benefits. Exposure is usually counted as the number of contract units of coverage for a specified time period. Typical units counted as exposures are members, subscribers, or contract units (such as families, couples, and single individuals.) The typical time unit for counting exposures is a month, although any reasonably constant time period may be used, such as a year or a week. As an example, if the exposure units being counted are members and the time period is months, then an exposure unit would be equivalent to coverage of one member for one month, which is frequently referred to as a member-month.

GAAP—Acronym for generally accepted accounting procedures.

IBNP—Acronym for incurred but not yet paid claims.

IBNP liability reserve amount—An IBNP liability reserve amount is an estimated amount of incurred but not yet paid (IBNP) claims as of a valuation date for which the payer is liable for payment. An IBNP liability reserve amount is typically first estimated by a payer's actuaries as a liability which is then recognized by the payer's accountants as a reserve. IBNP claim amounts may be estimated by incurred period prior to the valuation date and paid period following the valuation date; by totaling by incurred period or by paid period; or by totaling over all incurred periods or paid periods; or any combination of the preceding, depending on the requirements of the user. Thus a user may estimate IBNP liability reserve amounts as (a) IBNP claim amounts for claims incurred in a given incurred period before a valuation date and to be paid a given lag time later in a given paid period following the valuation date; (b) a total IBNP claim amount per incurred period; (c) a total IBNP claim amount per paid period; or, (d) a total IBNP liability reserve amount over all incurred/paid periods.

Incurred claims Method—The Incurred claims Method is a method traditionally used for estimating IBNP liability reserve amount that takes into account variance in claims reporting, processing and payment, but not in claims incurred. In so doing, the Incurred claims Method contains the implicit assumption that all variation in the amount of claims incurred and paid through a given valuation date is due solely to variance in the rate at which claims are reported, processed and paid, and that the amount of incurred claims per exposure per month (PMPM, or per exposure) does not vary from the total projected, including effects of such variables as trend and/or seasonality for which allowance is explicitly made. (see Overview—theoretical background section for further explanation).

Independence (of variables)—Two variables are independent if no relationship exists between them. The value observed for one variable does not affect the value which the other variable will take on. When a bivariate linear regression analysis is performed between two independent variables, and the assumed relationship is plotted in Cartesian coordinates in typical fashion, the result will be a horizontal line, indicating that the expected value of the assumed dependent variable is not affected by the value assigned to the independent variable.

Independent variable—In a mathematical expression relating two or more variables, the independent variable(s) is the “input” variable. When such mathematical relationships are displayed graphically using Cartesian coordinates, the independent variable is typically identified as the horizontal, or “x” axis. In functional representations of relationships, the dependent variable is expressed as a function of the independent variable. For example, in the expression y=f(x), x represents the independent variable, and y represents the dependent variable which takes on a unique value for each value of x for which the function f is valid. The term independent variable should not be confused with the concept of dependence or independence of variables.

Liability reserve error—A liability reserve error is the difference between the estimated IBNP liability reserve amount and the actual amount of incurred claims that are eventually paid at some time after the valuation date. The more accurate the estimated IBNP liability reserve amount, the smaller the liability reserve error.

Member—A member is an individual covered by an insurance plan in a given incurred period. In general usage, the term member may be expanded to include contract units of coverage.

Member-exposure unit—Exposure (see exposure above).

Paid Lag Method—The Paid Lag Method is the novel method of the present invention for estimating IBNP liability amounts, including the total IBNP liability reserve amount at a given valuation date.

Payer—A payer is an entity liable for payment of an incurred claim, e.g. an insurance carrier.

PMPM—An acronym for per member per month. Equivalent to per exposure per month, or per exposure values. Month may be replaced by another unit of time.

Simple Paid Lag Method—The Simple Paid Lag Method is one version of the Paid Lag Method of the present invention in which it is implicitly assumed that the IBNP amount for a given time period is independent of the amount of claims incurred and already paid. The statistical regression step is replaced by an averaging of historical paid lag claim amounts (see Detailed Description—method section for further details).

Regressed Paid Lag Method—The Regressed Paid Lag Method is one version of the Paid Lag Method of the present invention in which it is implicitly assumed that the IBNP claim amount for a given incurred period is related to or dependent on the amount of claims incurred and already paid. A statistical regression step is employed to estimate the degree of this dependence (see Detailed Description—method section for further details).

Regression—Mathematical regression random variables refers to a family of statistical techniques which require the assumption of an underlying relation between the variables. The most familiar form of regression is bivariate linear regression, which assumes a linear relationship between a single independent (“x”) variable, and a dependent (“y”) variable. The assumed relationship in bivariate linear regression is of the form γ=α+βx, where the value of regression parameter β is commonly referred to as the “slope”, and the value of the regression parameter α is commonly referred to as the “y-intercept”. If the variables are independent, then β will have a value of zero (0), and α will have a value equal to the average or mean value of the variable y. The underlying relationship may be of any form, including exponential, in which case the relationship is of the form y=αx^{β}, or polynomial, in which case the relationship is of the form y=α+β₁x+β₂x²+β₃x³+ . . . . If the variables are independent, then the relationship is of the form y=α, and α takes on the value of the average or mean value of the random variable y.

Seasonality—The tendency for the amount of incurred claim liabilities to vary in a consistent and predictable manner within the space of a calendar year. In health insurance, seasonality may be due to seasonal variations in morbidity (the rate at which individuals seek medical care), benefit design (such as when health plan has an annual deductible or annual out-of-pocket cost-sharing maximum), or calendar effects (for example, variation is monthly claims caused by the differing number of days in each month, or differences in the number of working days in a month.) Actuaries frequently attempt to recognize the effects of the different types of seasonality by making appropriate adjustments to claims incurred or paid in each month in the course of performing calculations.

Trend—The tendency of per-exposure health care costs to increase with time due to either increases in the rate of utilization of health care services, or changes in the amounts charged by providers for specific health care services. Commonly recognized components of trend include price inflation, changes in utilization rates, new products and technologies, and the claim trend leveraging effects of benefit cost-sharing components such as deductibles and copays. Actuaries usually attempt to adjust for the effects of trend in calculating future claim liabilities by apply an appropriate factor to past claim amounts and future claim projections. Alternatively, future claim liabilities by be calculated directly by assuming an underlying exponential form (y=αe^{βx}) for changes in claim costs with time. In the present invention, this latter approach would be implemented by applying an exponential regression rather than a linear regression technique when determining the regression parameters.

Time period—A time period is a period of time in which events such as an incurral of claims (i.e., an incurred period) or a payment of claims (i.e., a paid period) occurs. Typically, the time period is a month, but other periods of time may be employed in the system and method of the present invention.

Valuation date—A valuation date is the date as of which the value of assets or liabilities (in the present case, IBNP claim amounts) is determined, also know as the evaluation date.

Weighted average—A weighted average is calculated by assigning different weights (wᵢ) to each value of the random variable (xᵢ) for which the weighted average is being calculated. An arithmetic weighted average is then calculated as:
(w₁x₁+w₂x₂+w₃x₃+ . . . +w_{N}x_{N})/(w₁+w₂w₃ . . . w_{N})
A non-weighted average can be considered to be a special case of the more general weighted average in which all weighting values wᵢ are equal to 1.

Weighted regression—Weighted regression is performed by assigning weight values, wᵢ, to each of the values of the independent random variable, xᵢ, upon which the regression is performed with the intent of causing some values (such as those associated with recent time periods) a greater weight in determination of the regression parameters. Non-weighted regression is a special case of weighted regression in which the weights, wᵢ, are all assigned a value of one (1). Weighted averaging represents a special case of weighted regression in which the variables are assumed to be independent, so that the assumed relationship is y=α, where α is the (weighted) average value of the variable y.

### Overview—Generally

The method (and system for carrying out same) according to the present invention is, in overview, a method for estimating incurred but not yet paid (IBNP) claim liability reserve amounts by means of projecting paid claims per covered member by lag time based on adjusted average monthly paid amounts in historical data. This method is referred to herein as the Paid Lag method.

Two versions of this method are presented, the Simple Paid Lag Method, which assumes that future paid claim amounts are independent of claims incurred and already paid, and the Regressed Paid Lag Method, which assumes that future paid claims are correlated with cumulative incurred and paid claims through the valuation date. Both versions of the Paid Lag Method have been shown to give significantly more accurate results than the traditional Completion Factor and Incurred claims Methods when applied to sets of real data.

The reader is referred to other works by the Applicant for further information regarding the present invention including: Robert G. Lynch, Calculation of IBNP Reserves with Low Variance, Health Section News, August 2003; and, Robert G. Lynch, A New Method for Calculating IBNP Health Reserves with Low Variance, Contingencies, Jan-Feb, 2004 (these references are incorporated herein in their entirety by reference).

### Overview—Theoretical Background

As discussed in the Background section, the Completion Factor and Incurred claims Methods for estimating IBNP liability reserve amount yield inaccurate results. The poor performance of these two estimation methods can be explained by an examination of the underlying process of claim incurred and payment which they are intended to quantify. The basic process can be broken down into two, more or less independent component processes contributing to overall process variance: (1) claim incurred and (2) claim reporting, processing, and payment. Neither the Completion Factor or Incurred claims Methods account properly for these sources of process variance, thereby resulting in estimates of IBNP liability reserve amounts with high method variance. The Completion Factor Method takes into account variance in claims incurred, but not in claims reporting, processing and payment. Whereas, the Incurred claims Method accounts for variance in claims reporting, processing and payment, but not in claims incurred.

The first process, claims incurred, can be represented as a random variable, Φ(m,i), which represents the claim liability incurred by member m in month i. Let Mᵢ be the set of members in month i. The total claims incurred in month i is then simply the summed random variable:

$${Φ}^{Total} ( i ) = {\sum }_{m} Φ ( m , i ) for all m ɛ {M}_{i}$$

The claim reporting, processing and payment process can be represented by a second random variable, Θ(l), which measures the probability that a claim incurred in month i will be paid before the end of month i+l, where l=0, 1, 2, . . . . The convolution of Φ(m,i) and Θ(l) then represents a measure of the amount of claims incurred by member m in month i, and paid before the end of month i+l, Φ(m,i)•Θ(l). If Ψ(m,i,l) is defined as the random variable describing claims incurred by member m in month i and paid before the end of month i+l, then the total claims incurred and paid for month i by the end of month i+l is the sum:

$${Ψ}^{Total} ( i , l ) = {\sum }_{m} Ψ ( m , i , l ) = {\sum }_{m} [ Φ ( m , i ) \cdot Θ ( l ) ] for all m ɛ {M}_{i}$$

Since all claims are paid or settled eventually, it is required that as i gets large, Ψ(m,i,l) converges to Φ(m,i), so Θ(l) converges to the Identity.

When Ψ^{Total}(i,l) is compared to the process implied by the Completion Factor Method, it is clear that the Completion Factor Method implicitly assumes that Θ(l) is a deterministic function of l, so that the value assumed by Θ(l) is fixed for any given lag time l. In other words, the only variability recognized by the Completion Factor Method is in the process of claims incurred, and no allowance is made for variation in the rate of claims reporting, processing and payment. This implies that:

$$\begin{matrix}{Ψ}^{Total} ( i , l ) = {\sum }_{m} Ψ ( m , i , l ) = ( {\sum }_{m} Φ ( m , i ) ) * E [ Θ ( l ) ] \\ for all m ɛ {M}_{i}\end{matrix}$$

which is false, since in general

$${\sum }_{m} [ Φ ( m , i ) \cdot Θ ( l ) ] \neq ( {\sum }_{m} Φ ( m , i ) ) * E [ Θ ( l ) ] .$$

The practical result of this attempt to estimate Ψ^{Total}(i,l) with an inappropriate model is that the error variance of the final result is very high. This is due to the fact that, even if

$$E [ {Ψ}^{Total} ( i , l ) ] = E [ {\sum }_{m} Φ ( m , i ) ] * E [ Θ ( l ) ] ,$$

this estimator for Ψ^{Total}(i,l) is a product of two other distinct estimators. Thus the variance of the final estimator is proportional to the product of the variances of the two estimating parameters separately.

Likewise, when Ψ^{Total}(i,l) is compared to the process implied by the Incurred claims Method, it is clear that the Incurred claims Method implicitly assumes that Φ(m,i) is a deterministic function of m and i. In other words, the only variance recognized is in the process of claims reporting, processing and payment, and-no allowance is made for variance in the actual rate of claims incurred. This implies that:

$${Ψ}^{Total} ( i , l ) = {\sum }_{m} Ψ ( m , i , l ) = {\sum }_{m} E [ Φ ( m , i ) ] * Θ ( l ) for all m ɛ {M}_{i}$$

which is also false, since in general

$${\sum }_{m} [ Φ ( m , i ) \cdot Θ ( l ) ] \neq {\sum }_{m} E [ Φ ( m , i ) ] * Θ ( l ) .$$

The reader will see that, since dealing with the convolution Φ(m,i)•Θ(l) is impractical, the alternative is to work directly with the random variable Ψ(m,i,l). If a direct estimator of Ψ(m,i,l) is used, then standard linear statistical methods may also be applied to its sum,

$${Ψ}^{Total} ( i , l ) = {\sum }_{m} Ψ ( m , i , l ) .$$

The method of the present invention does this by using a direct estimator of Ψ(m,i,1), thus enabling application of standard linear statistical methods, as described in further detail following. The method of the present invention described following, is essentially concerned only with the estimation of parameters of the probability function Ψ, which results from the convolution of the two distinct processes of claims incurred and claims processing.

### DETAILED DESCRIPTION—METHOD

The computer-implemented method of the present invention is a method for estimating amounts of reserve liabilities for incurred but not yet paid (IBNP) insurance claims as of a given valuation date so as to minimize liability reserve errors, to maintain statutorily required minimum EBNP liability reserve amounts and to comply with GAAP and statutory reporting requirements in financial statements. Moreover, the computer-implement method of the invention executes the method of the invention as set forth above. The method of the present invention is hereinafter referred to as the Paid Lag Method.

The reader will please note that though the following description details certain versions of the method, other equivalents are also available to a user. For example, though the following description generally assumes that the number of exposures per time period will vary, and therefore accounts for this variation by calculating per-exposure values, this is not a necessary step. A user may assume, for example, that exposures are relatively constant over time periods and therefore, calculate gross rather than per-exposure values. Likewise, though time periods are generally expressed in terms of months below, a time period may be any unit of time depending on the needs of the user.

In the Paid Lag Method, the total liability reserve amount for IBNP claims at a given valuation date is calculated as the sum, for all past member-exposures, of the projected per exposure amounts to be paid in time periods after the valuation date (i.e., paid periods) for claim amounts incurred in time periods (i.e., incurred periods) up to the valuation date, summed for all members for which there are potential outstanding claim liabilities. The amount of elapsed time from a point in an incurred period to an equivalent point in a paid period is the lag time. The projected incurred but not yet paid (EBNP) paid lag claim amounts per covered member by lag time are based on adjusted average monthly paid amounts in historical data. This method yields estimates with significantly lower error than previous methods, including the Completion Factor and Incurred claims Methods (discussed above in Background and Overview-Theoretical Background sections).

Two versions of the Paid Lag Method are presented, the Simple Paid Lag Method and the Regressed Paid Lag Method. The Simple Paid Lag Method assumes that future paid claim amounts are independent of claims incurred and already paid. The Regressed Paid Lag Method assumes that future paid claims are correlated with cumulative incurred and paid claims through the valuation date. Both versions of the Paid Lag Method gave significantly more accurate results than the traditional Completion Factor and Incurred claims Methods when applied to sets of real data (see, Robert G. Lynch, Calculation of IBNP Reserves with Low Variance, Health Section News, August 2003; and, Robert G. Lynch, A New Method for Calculating IBNP Health Reserves with Low Variance, Contingencies, Jan-Feb, 2004).

Simple Paid Lag Method. The first, and most direct, way to apply the above-mentioned approach to estimation of IBNP amounts is to use the Simple Paid Lag version of the method. In this version it is assumed that the appropriate estimator for Ψ(m,i,l) is the arithmetic mean of the historic realized values of Ψ(m,i,l) for all members (or exposures) m, incurred periods i and lag times l before the valuation date, optionally adjusted for such time-dependent variables as trend and seasonality. This Simple Paid Lag Method approach, carries the implicit assumption that Ψ(m,i,L) is independent of

$${\sum }_{l} Ψ ( m , i , l ) for all l < L .$$

Regressed Paid Lag Method. Alternatively, the possible dependence of Ψ(m,i,L) with ΣΨ(m,i,l) (0≦l≦L) may be estimated and adjusted for by employing the Regressed Paid Lag version of the method. If it is assumed that there is a linear relation between the two, then linear regression of the historic realized values of Ψ(m,i,L) against the corresponding cumulative values, ΣΨ(m,i,l) (where 0≦l≦λ for all λ<L), will yield two arrays of regression parameters, α_{i,l} and β_{/l}, respectively, as the slope and intercept parameters to generate the incurred claims estimators (see step 600 below). Let Mᵢ be the cardinality of Mᵢ, that is, the number of members in each respective incurred period i. Then the estimator of claims incurred in period i, paid in lag time i+l, given claims incurred in period i and cumulatively paid through period i+L (L<l), is

$$E [ Ψ ( m , i , L ) ] = {β}_{i , l} + {α}_{i , l} * {\sum }_{m} {\sum }_{λ} Ψ ( m , i , λ ) \div {M}_{i} \\ ( all m ɛ {M}_{i} , 0 \leq λ < L )$$

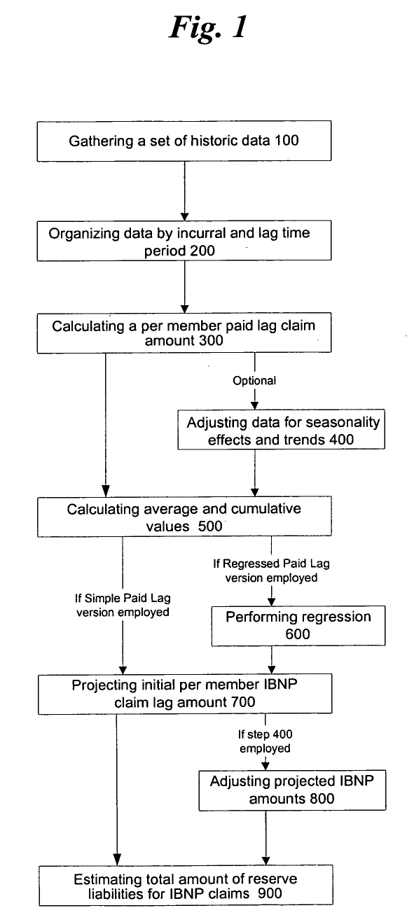

The following describes the basic steps in the method of the present invention (see FIG. 1).

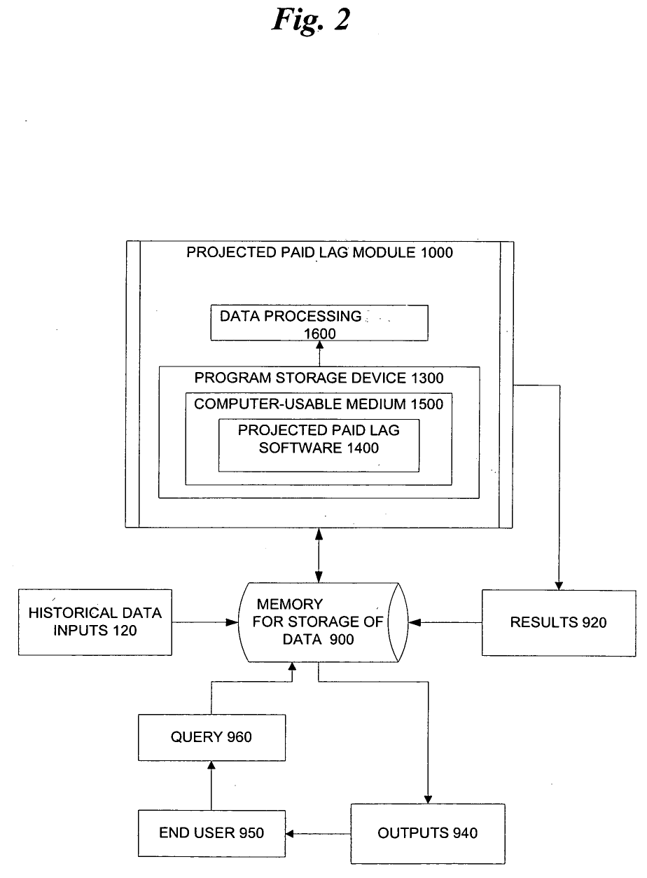

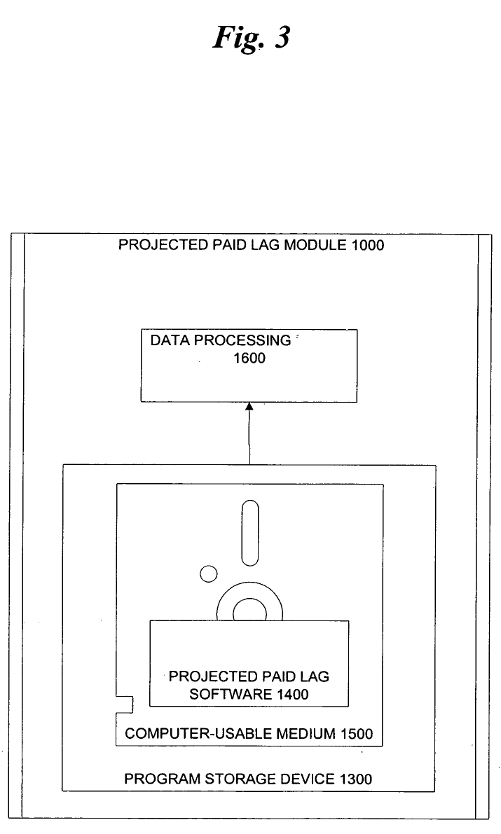

Accessing a set of historical data 100. A computer system for executing the method of the present invention is provided as described below (see Description—System section). The computer system has memory 900 for the accessible storage of data (such as a database, etc.) and data processor 1600 (see FIGS. 2 and 3).

A set of historical data 120 is accessibly stored in memory 900 and will generally be provided by a user or the payer, if not the same as the user. The set of historical data 120 contains, for each of a number of time periods prior to a valuation date, a number of exposures, M, and a total incurred and paid claim amount for each combination of incurred and paid periods. The total incurred and paid claim amount is a total actual amount of claims incurred in a given incurred period and paid in a given paid period, the incurred period and the paid period each being one of the time periods (i.e., C_{p,i}—an amount of claims that were incurred in an incurred period i and paid in a paid period, p).

The data may further include a paid lag claim amount for each combination of incurred and paid periods. The paid lag claim amount is the total incurred and paid claim amount reorganized by the incurred period and by a lag time to generate a total incurred and paid claim amount per incurred and lag time over all incurred, lag, and paid time periods, the lag time being a measure of elapsed time from claim incurral to claim payment. Lag time is measured from a point in the claim incurral time period to an equivalent point in the claim paid period (e.g., from the start of the claim time period to the start of the claim paid period; from the end of the claim time period to the end of the claim paid period; or the like). If paid lag claim amounts are not provided, the user may generate them by performing step 200 below. The data may still further include a per exposure paid lag claim amount, the per exposure paid lag claim amount being the total incurred and paid claim amount per incurred and paid period divided by the number of members in the incurred period over all incurred and paid periods (if not provided, the user may generate these values by performing step 300 below).

Time periods may be any user-defined period of time, however, as used throughout this description, a time period is a month.

The purpose of this step 100 is to access collected past claims experience into an ordered format for use in the various calculations and estimations of the method. The conventional format used here by way of example is a matrix where columns represent the calendar months i in which claims were incurred (i.e. incurred periods), and rows represent calendar months p in which claims were paid (i.e. paid periods). Thus, the contents of a particular cell of the matrix represent claims incurred in the calendar month i corresponding to the particular cell's column, and paid in the calendar month p corresponding to the particular cell's row. The reader will please note that the time period used in this description is months, since that is the most common time period used in reserve calculations, but any time period may be used.

Historical raw data (120; FIG. 2) is, as mentioned above, initially gathered in a matrix format with calendar month of claims incurred (i.e., incurred periods) in columns going across and calendar month of claims payment (i.e., paid periods) in rows going down. In this lower-triangular format, the claim amount C_{p,i} in row p and column i represents claims incurred in month i and paid in month p. This layout is represented for N months of claims incurred and paid data in the sample matrix in Table 1.

The example shown here is based on N months of claims incurred (with N being the most recent month for which paid claims are available) and N months of claims payment. However, the number of months of incurred may exceed the number of months of claims payment for older months if claims are deemed to be essentially completed before N months of claims payment run-out.

TABLE 1
Initial Claims Data in Lower-Triangular Matrix Format

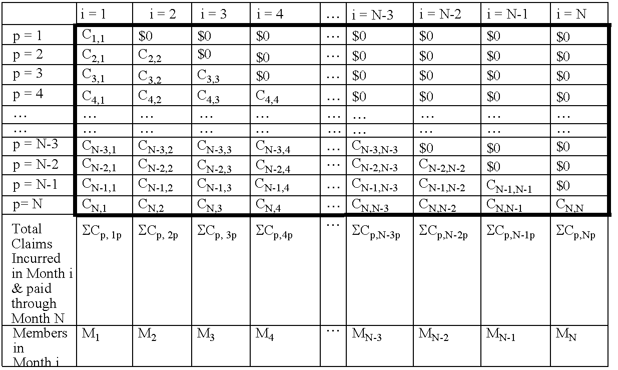

Organizing data by incurred period and lag time for total paid lag claim amount C_{l,i} 200 [optional]. The set of historical data inputs 120 in memory 900 of the computer system may or may not be provided with incurred and paid claim amounts organized by incurred and lag time. If not provided in this format, the historical data 120 is processed to organize the total claim amounts by the incurred period, i, and by a lag time, l, the lag time being a measure of elapsed time from claim incurred period, i, to paid period, p, to generate a total incurred and paid claim amount per incurred period and lag time over all incurred periods and lag times, C_{l,i}.

The claim lag time is a measure of elapsed time from claim incurral to claim payment. Lag time is measured from a point in the claim incurred period to an equivalent point in the claim paid period (e.g., from the start of the claim time period to the start of the claim paid period; from the end of the claim time period to the end of the claim paid period; or the like, so long as the definition is applied consistently).

The purpose of this step 200 is merely to rearrange the historic claims data 120 gathered in step 100 into a different format (if not provided in this format by the user). In this new format, columns continue to represent incurred periods, i.e., calendar months of claims incurred, i, as in Step 100, but ordering of the rows now represent the number of months after date of claims incurred in which the claim was paid (the number of months of payment lag, l, or lag time) rather than the calendar months in which claims were paid, p.

The effect on the presentation is to move the non-zero cells from Step 100 upward, so that the first cell in each column represents claims paid in the same month as incurred for the calendar months corresponding to the respective columns, the second row represents claims paid in the calendar month immediately following the calendar month of incurred, and so on. This new organization of the data 120 facilitates calculation in subsequent steps.

Thus, the data in the lower triangular data matrix of Table 1 is rearranged into an upper matrix form so that claim amounts in row 1 and column i represent claim amounts incurred in month i and paid in lag time l, where i+l=p. Claims paid in the same month as they are incurred are given a lag value of l=0. The data from Table 1 is shown in Table 2, rearranged into upper matrix form, but with the claim amounts still labeled according to paid month, p, and incurred period, i. In Table 3, the data of Table 2 is relabeled to conform with the respective lag time, l, and incurred period i. The total claims incurred in month i and paid through month N remains unchanged since the data has only been rearranged by row, not by column.

In the rearranged matrix, the cells to the lower right (lag time l>N−i) are empty, since the amounts which would be entered in these cells represent claims incurred but not yet paid (IBNP). These IBNP amounts are the unknown amounts to be calculated. The sum of the amounts of incurred and paid claims, C_{l,i}(i.e., claim amounts incurred in month i and paid in lag time l), for all I greater than N−i and all incurred periods i, represents the incurred claim liability or reserve which is to be determined.

TABLE 2
Initial Claims Data Rearranged to Upper-Triangular Matrix Format

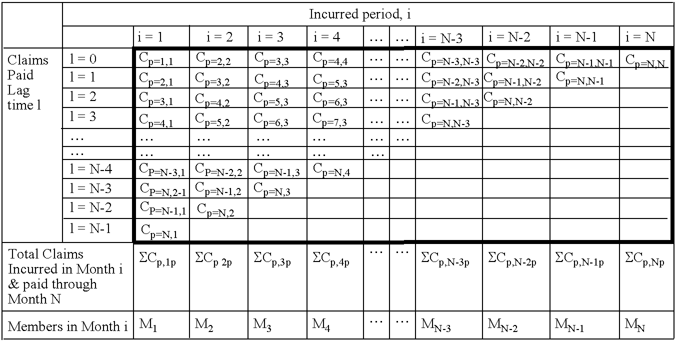

TABLE 3
Initial Claims Data Relabeled to Upper-Triangular
Incurred vs. Lag Matrix Format.

| | Incurred period, i | | | | | | | | | |
|---|---|---|---|---|---|---|---|---|---|---|
| | i = 1 | i = 2 | i = 3 | i = 4 | . . . | . . . | i = N − 3 | i = N − 2 | i = N − 1 | i = N |
| Claims Paid in | | | | | | | | | | |
| Lag time, l | | | | | | | | | | |
| l = 0 | C_{0,1} | C_{0,2} | C_{0,3} | C_{0,4} | . . . | . . . | C_{0,N-3} | C_{0,N-2} | C_{0,N-1} | C_{0,N} |
| l = 1 | C_{1,1} | C_{1,2} | C_{1,3} | C_{1,4} | . . . | . . . | C_{1,N-3} | C_{1,N-2} | C_{1,N-1} | |
| l = 2 | C_{2,1} | C_{2,2} | C_{2,3} | C_{2,3} | . . . | . . . | C_{2,N-3} | C_{2,N-2} | | |
| l = 3 | C_{3,1} | C_{3,2} | C_{3,3} | C_{3,3} | . . . | . . . | C_{3,N-3} | | | |
| . . . | . . . | . . . | . . . | . . . | . . . | . . . | | | | |
| . . . | . . . | . . . | . . . | . . . | . . . | | | | | |
| l = N − 4 | C_{N-4,1} | C_{N-4,2} | C_{N-4,3} | C_{N-4,4} | | | | | | |
| l = N − 3 | C_{N-3,1} | C_{N-3,2} | C_{N-3,3} | | | | | | | |
| l = N − 2 | C_{N-2,1} | C_{N-2,2} | | | | | | | | |
| l = N − 1 | C_{N-1,1} | | | | | | | | | |
| Total Claims Incurred in Month i & Paid through Month N | ${\sum }_{l < N} {C}_{l , 1}$ | ${\sum }_{l < N - 1} {C}_{l , 2}$ | ${\sum }_{l < N - 2} {C}_{l , 3}$ | ${\sum }_{l < N - 3} {C}_{l , 4}$ | . . . | . . . | ${\sum }_{l < 4} {C}_{l , N - 3}$ | ${\sum }_{l = 0 , 1 , 2} {C}_{l , N - 2}$ | ${\sum }_{l = 0 , 1} {C}_{l , N - 1}$ | ${\sum }_{l = 0} {C}_{l , N}$ |
| Members in Month i | M₁ | M₂ | M₃ | M₄ | . . . | . . . | M_{N-3} | M_{N-2} | M_{N-1} | M_{N} |

Calculating a iper exposure paid lag claim amount. C′_{l,i} 300 [optional]. If not otherwise provided, a per exposure paid lag claim amount, C′_{l,i}, is calculated by processing information in memory 900 of the computer system. The total incurred and paid claim amount per incurred and lag time, C_{l,i}, is divided by the number of exposures, M, in the incurred period over all incurred periods and lag times.

The purpose of this step is to convert total claim amounts for an entire block of business for each cell in Step 200 to average per exposure paid lag claim amounts, C′_{l,i}. This step is necessary to make subsequent calculations independent of month-to-month changes in the number of members for whom claim cost liabilities are incurred.

Each gross incurred and paid claim amount C_{l,i}, is converted to the respective intrinsic per exposure per month (PMPM, or, per member per month) value, C′_{l,i}, by dividing by the number of exposures in each incurred period, Mᵢ.
C′_{l,i}=C_{l,i}/Mᵢ for all i and all l<=N

The resulting matrix of average per exposure paid lag claim amounts, C′_{l,i}, paid in each lag time, l, following the month of claim incurred, i, appears as in Table 4.

TABLE 4
Claims Data Normalized to Per ExposureValues, C′l,I

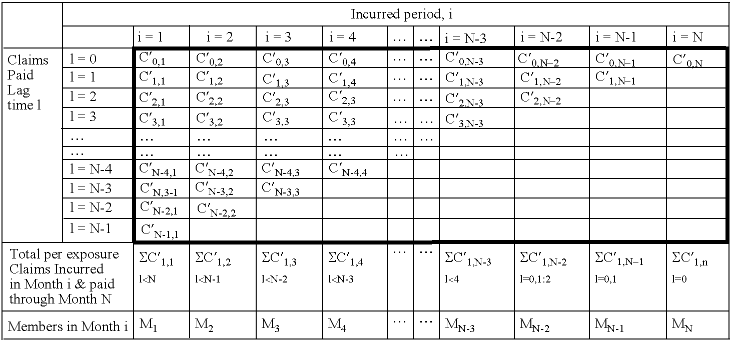

Adjusting claims Data for Seasonality Effects and Trend 400 [optional]. The purpose of this optional step is to correct the per exposure paid lag claim amounts for variations due to processes extrinsic to the IBNP liability calculation that are either known or separately estimated. These adjustments serve to minimize the effects of these extrinsic variables regardless of the actual IBNP claims projection method used. Adjustments made in this step (if the step is optionally employed) are reversed in Step 800. Please note that though this step further improves the accuracy of the IBNP estimate, it is optional to the Paid Lag Method of the present invention.

According to this step, the claims data may be adjusted for seasonality affects due to deterministic variables such as number of calendar days in each month, or estimated factors such as seasonal morbidity or cumulative effects of benefit or patient cost-sharing limits. This step is implied in the tables, and is not shown explicitly.

The claims data is also adjusted for removal of the effects of trend, using either arithmetic or geometric parameter estimates. The end effect is to make the adjusted values seasonality- and trend-neutral.

Calculating average paid lag claim amounts, C′_{l,i} 500. An average per exposure paid lag claim amount, C*ₗ, is calculated by summing, for each lag time, the per exposure paid lag claim amount, C′_{l,i}, over all incurred periods, i, and dividing by the sum of the number of exposures over all incurred periods. Cumulative values of C′_{l,i} may also be calculated for use in the optional statistical regression step 600.

The purpose of this step is to determine the average amount of paid claims per exposure by claims payment lag time (i.e., the average per exposure paid lag claims amount, C*ₗ). In the Simple Paid lag method, this average value, C*ₗ, is used as the basis for projection of future paid claim amounts for incurred periods prior to the valuation date, but with claim paid periods after the valuation date.

For each value of l ε (0, 1, 2, . . . , N), define the member-weighted mean value of C′_{l,i} as
C*ₗ=ΣMᵢ*C′_{l,i}/ΣMᵢ for all i<=N−1

If the only weighting to be used is the number of exposures in each incurred period, i, then this is equivalent to taking a direct average to obtain C*ₗ:
C*ₗ=ΣC_{l,i}/ΣMᵢ for all i<=N−1

If the user wishes to apply a weighting to the various time periods (for example, to give greater credibility to more recent time periods), then an appropriate weighting value, w_{l,i}, may be determined for each of the various time periods and applied as follows:
C*ₗ=Σw_{l,i}*Mᵢ*C′_{l,i}/Σw_{l,i}*Mᵢ for all i<=N−l

A cumulative paid lag amount as of the valuation date for a selected incurred period is the sum of paid lag claim amounts for one or more paid periods or the sum of paid lag claim amounts for one or more paid periods multiplied by a weighting factor. The cumulative claim amount C^{Σ}_{λ,i} without a weighting factor is given by:
C^{Σ}_{λ,i}=ΣC′_{l,i} for all i<=N−l

Alternatively, when the weighting factor is 1/Mᵢ the cumulative paid claim amount is a cumulative per exposure paid lag claim amount and is calculated by summing the exposure claim amount over all incurred periods and lag times.
C^{Σ}_{λ,i}=ΣC′_{l,j} for all i and all l<=λ

Performing a statistical regression of values of C′_{l,i} against cumulative values of C^{Σ}_{l,i} 600.

The purpose of this step is to improve the predictability of calculated average per exposure paid lag claim amount, C*ₗ, by statistical regression. In general, paid lag claim amounts are regressed against cumulative paid claim amounts. In one variation, paid claim amounts C_{l,i} are regressed against C^{Σ}_{λ,i} without a weighting factor. In another variation, paid claim amounts are regressed against C^{Σ}_{λ,i} with a weighting factor. When the weighting factor is 1/Mᵢ the paid claim amounts are per exposure claim amounts, C′_{l,I}, and the C^{Σ}_{λ,i} are per exposure cumulative paid claim amounts.

In implementing the regression analysis, a functional relationship between cumulative paid lag claim amounts and paid lag claim amounts is identified. The functional relationship will have one or more adjustable parameters. Moreover, the cumulative paid lag claim amounts, C^{Σ}_{λ,i}, are independent variables. As set forth above, the cumulative paid lag claim amount for a selected incurred period is the sum of paid lag claim amounts for one or more paid periods or the sum of paid lag claim amounts for one or more paid periods multiplied by a weighting factor. In establishing the functional relationship, the paid lag claim amounts are dependent variables (C′_{l,i} when per exposure values are used or C_{l,i} when no weighting factor is used). In the regression analysis, the one or more adjustable parameters are adjusted to obtain optimized parameters such that a predetermined function of differences between calculated paid lag claim amounts and actual paid lag claim amounts is minimized. Typically, this function of differences is the square of the differences and the analysis is a least squares analysis.

When a least squares analysis is used, two arrays of slope (α) and intercept (β) regression parameters must be calculated, where the values of the α and β for each combination of number of cumulative paid claims and runout beyond the end of the paid period are used to calculate the projected paid claim for the incurred period in a given future payment month. This calculation takes the form of {amount of claims to be paid in future payment month} equals β plus (x times [cumulative claims paid for given claim incurred period as of valuation date], for each combination of past claims incurred period and future claims payment month.

Values of C*ₗ may be either used directly to project future claim liability reserves (as in the Simple Paid Lag version of the method; i.e. go to 700 without performing 600), or the Regressed Paid Lag version of the method may be employed as per present step 600, in which the estimates (from step 500 above) can be improved further by statistical regression of the per exposure historic values of C′_{l,i} [the dependent random variable describing claims incurred by member m in month i and paid before the end of month i+l] against the corresponding cumulative values of C^{Σ}_{l,i} (the independent random variable).

Alternatively, the possible dependence of Ψ(m,i,L) (i.e., the random variable used to describe claim liability incurred by members m in month i and paid in lag time l) with Σ Ψ(m,i,l) (0≦l≦L) may be estimated and adjusted for by employing the Regressed Paid Lag version of the method. If it is assumed that there is a linear relation between the two, then linear regression of the historic realized values of Ψ(m,i,L) against the corresponding cumulative values, ΣΨ(m,i,l) (where 0≦l≦λ for all λ<L), will yield two arrays of regression parameters, α_{i,l} and β_{i,l}, respectively, as the slope and intercept parameters to generate the incurred claims estimators. Let Mᵢ be the cardinality of Mᵢ, that is, the number of members in each respective incurred period i. Then the estimator of claims incurred in month i, paid in lag time i+l, given claims incurred in month i and cumulatively paid through month i+L (L<l), is

$$E [ Ψ ( m , i , L ) ] = {β}_{i , l} + {α}_{i , l} * {\sum }_{m} {\sum }_{λ} Ψ ( m , i , λ ) \div {M}_{i} ( all m {ɛM}_{i} , 0 \leq λ < L )$$

If a linear least-squares regression model is used, then for each combination of lag time l and cumulative lag times λ regression parameters of slope, α_{λ,l}, and intercept, β_{λ,l}, must be calculated. The regressed slope and intercept parameters as α_{λ,l}, and β_{λ,l}, respectively, are identified. The regression may be performed on values of of C′_{l,i} and C^{Σ}_{l,i} weighted by the number of members in each incurred period, Mᵢ, or other weighting parameter as appropriate to the circumstances. For example, if more recent claim incurred and payment patterns are considered to be more representative of expected future claim runout payments, then a time-dependent weighting factor wᵢ may be used, where wᵢ≦wᵢ₊₁ for all i. The results can be shown in matrices presented in Table 5 and Table 6, respectively.

TABLE 5
Slope Regression Parameters from Linear Regression of per exposure
Values of C′_{l,i} against Cumulative values of C^{Σ}_{l,i}

| | Cumulative Incurred and Paid Claim Lags, λ | | | | | | | | | |
|---|---|---|---|---|---|---|---|---|---|---|
| | | λ = 0 | λ = 1 | λ = 2 | λ = 3 | . . . | λ = N − 4 | λ = N − 3 | λ = N − 2 | λ = N − 1 |
| Claims | l = 1 | α_{0,1} | | | | | | | | |
| Paid | l = 2 | α_{0,2} | α_{1,2} | | | | | | | |
| Lag | l = 3 | α_{0,3} | α_{1,3} | α_{2,3} | | | | | | |
| time, l | l = 4 | α_{0,4} | α_{1,4} | α_{2,4} | α_{3,4} | | | | | |
| | . | . | . | . | . | . . . | | | | |
| | . | . | . | . | . | . . . | | | | |
| | . | . | . | . | . | . . . | | | | |
| | l = N − 3 | α_{0,N-3} | α_{1,N-3} | α_{2,N-3} | α_{3,N-3} | . . . | α_{N-4,N-3} | | | |
| | l = N − 2 | α_{0,N-2} | α_{1,N-2} | α_{2,N-2} | α_{3,N-2} | . . . | α_{N-4,N-2} | α_{N-3,N-2} | | |
| | l = N − 1 | α_{0,N-1} | α_{1,N-1} | α_{2,N-1} | α_{3,N-1} | . . . | α_{N-4,N-1} | α_{N-3,N-1} | α_{N-2,N-1} | |
| | l = N | α_{0,N} | α_{1,N} | α_{2,N} | α_{3,N} | . . . | α_{N-4,N} | α_{N-3,N} | α_{N-2,N} | α_{N-1,N} |

TABLE 6
Intercept Regression Parameters from Linear Regression of per exposure
Values of C′_{l,i} against Cumulative values of C^{Σ}_{l,i}

| | Cumulative Incurred and Paid Claim Lags, λ | | | | | | | | | |
|---|---|---|---|---|---|---|---|---|---|---|
| | | λ = 0 | λ = 1 | λ = 2 | λ = 3 | . . . | λ = N − 4 | λ = N − 3 | λ = N − 2 | λ = N − 1 |
| Claims | l = 1 | β_{0,1} | | | | | | | | |
| Paid | l = 2 | β_{0,2} | β_{1,2} | | | | | | | |
| Lag | l = 3 | β_{0,3} | β_{1,3} | β_{2,3} | | | | | | |
| time, l | l = 4 | β_{0,4} | β_{1,4} | β_{2,4} | β_{3,4} | | | | | |
| | . | . | . | . | . | . . . | | | | |
| | . | . | . | . | . | . . . | | | | |
| | . | . | . | . | . | . . . | | | | |
| | l = N − 3 | β_{0,N-3} | β_{1,N-3} | β_{2,N-3} | β_{3,N-3} | . . . | β_{N-4,N-3} | | | |
| | l = N − 2 | β_{0,N-2} | β_{1,N-2} | β_{2,N-2} | β_{3,N-2} | . . . | β_{N-4,N-2} | β_{N-3,N-2} | | |
| | l = N − 1 | β_{0,N-1} | β_{1,N-1} | β_{2,N-1} | β_{3,N-1} | . . . | β_{N-4,N-1} | β_{N-3,N-1} | β_{N-2,N-1} | |
| | l = N | β_{0,N} | β_{1,N} | β_{2,N} | β_{3,N} | . . . | β_{N-4,N} | β_{N-3,N} | β_{N-2,N} | β_{N-1,N} |

Projecting IBNP claim amounts 700. An IBNP claim amount is an estimated paid lag claim amount for claims incurred in a given incurred period before the valuation date which will be paid a given lag time following the valuation date. The IBNP claim amount is projected by setting it equal to the regressed paid lag claim amount for the given incurred period and lag time.

When the IBNP claim amount is a per exposure IBNP claim amount, the per exposure per month amounts for claims incurred in or before month M_{N} but not paid until after month M_{N}, i.e., C*_{l,i}, are determined using values of C*ₗ that have either been regressed (if Regressed Paid Lag version employed; see step 600), or not (if Simple Paid Lag version employed; see step 500). In other words, for the Simple Paid Lag version, the average estimated values C*ₗ are taken to represent (i.e., projected to be) what is to be expected in the future.

If the Regressed Paid Lag version of the method is employed, the purpose of this step is to apply the regression parameters, α and β, calculated in the previous step (600) to calculate the regressed estimate of IBNP claim liabilities by lag time.

Table 7 shows the labeling scheme for the initial projected per exposure IBNP claim amounts, C*_{l,i}. Values in the lower right of the matrix (i.e., cells below the double border) represent projected IBNP amounts by incurred period i and lag time l (i+l>N), while values in the upper left half of the matrix, above the double border, represent claims incurred in month i and already paid in lag time l (i+l<=N).

TABLE 7
Projected Values of per exposure Incurred But Not Paid Claims, C*l,i

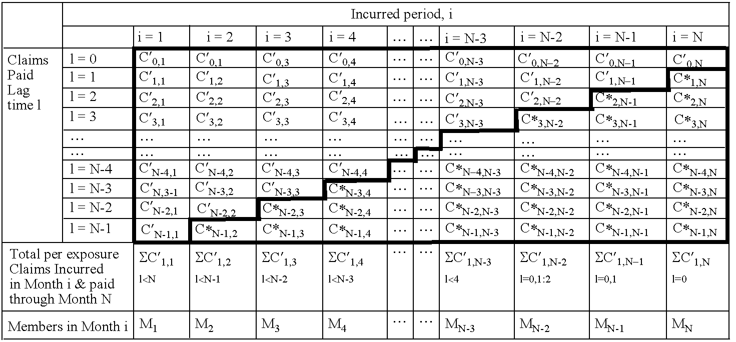

If the Regressed Paid Lag version of the method is employed and regressed values of C*ₗ are used, then the per exposure IBNP amounts for claims incurred in or before month M_{N} but not paid until after month M_{N} are determined as:
C*_{l,i}=β_{λ,l}+(α_{λ,l}×C^{Σ}_{λ,i})

If the Simple Paid Lag version of the method is employed and values of C*ₗ are not regressed, then C*_{l,i}=C*ₗ for all i.

Table 8 shows the completed per exposure claims matrix for values of C*_{l,i} if the projected values are not regressed (i.e. Simple Paid Lag version of method employed). Table 9 shows the regressed values of C*_{l,i} if the per exposure claim amounts are regressed and projected using the values of C^{α}_{λ,l}, and C^{β}_{λ,l} as described (i.e. Regressed Paid Lag version of the method employed). For clarity, the formulae for calculation of the various values of C*_{l,i} are shown in Table 9. In both Tables 8 and 9, the values in the lower right half of the matrix (i.e., cells below the double border) are the initial projected per exposure incurred but not yet paid amounts.

Table 8. Projected Values of per exposure Incurred But Not Paid claims, C*_{l,i}, without Regression (C*_{l,i}=C*ₗ) [Simple Paid Lag version]

TABLE 8
Projected Values of per exposure Incurred But Not Paid Claims, C*_{l,i},
without Regression (C*_{l,1} = C*ₗ) [Simple Paid Lag version]

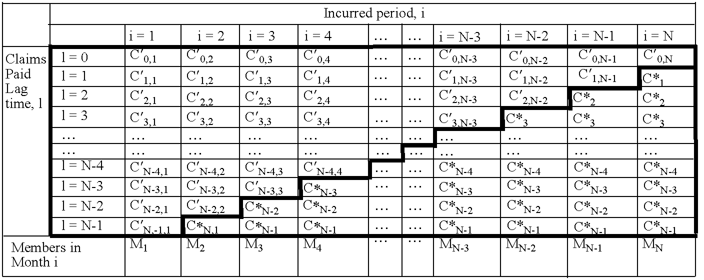

TABLE 9
Projected Values of per exposure Incurred But Not Paid Claims, C*_{l,1},
with Regression [Regressed Paid Lag version].

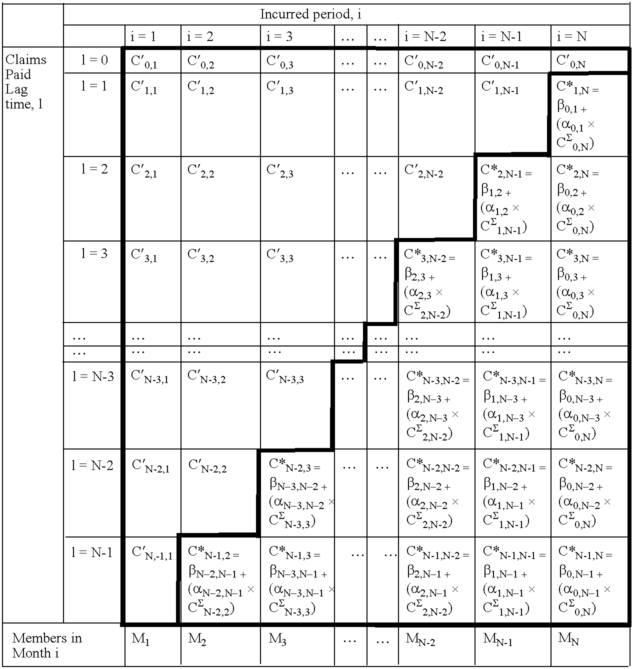

Note that if optional step 400, adjusting for trend, is not employed, the regression performed in this step may be an exponential instead of a linear regression.

Adjusting Projected Values of C*_{l,i} for Trend and Seasonality 800 [optional]. In this step, the adjustments for trend, seasonality, etc., which were applied in Step 400 above (if optionally employed), are essentially reversed to reintroduce known or estimated extrinsic effects on the IBNP claim liability estimates.

Thus, projected values of per exposure IBNP claim amounts are then adjusted in the reverse of procedure used in 400. These adjusted per exposure values are designated as C\hat{ }_{l,i} for claims incurred in month i and projected to be paid in lag time l. Table 10 shows the completed per exposure claims matrix. Values in the upper left (C′ₗ) are incurred and paid per exposure amounts from Step 300 (Table 4), while values in the lower right (C\hat{ }_{l,i}) are the estimated per exposure IBNP claim amounts.

TABLE 10
Completed Estimates of per exposure IBNP Claim Amounts, C\hat{ }l,i,
Incurred in Month i and Paid in Lag time l.

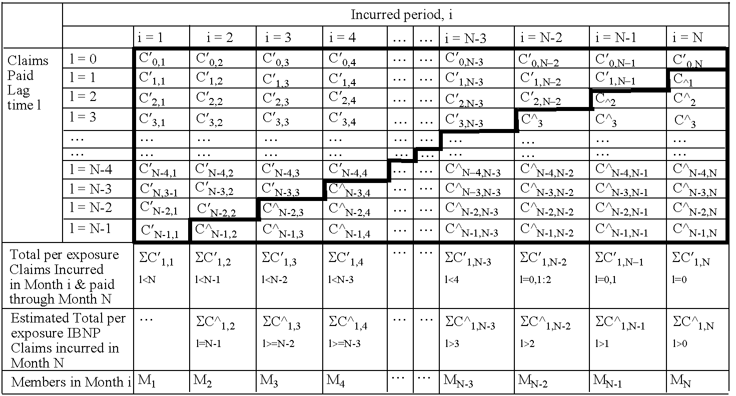

Estimating total amount of reserve liabilities for IBNP claims 900. An amount of reserve liabilities for IBNP claims per incurred period is estimated by summing the projected per exposure IB NP claim lag amounts by incurred period and then multiplying the resulting sum by the number of exposures in each incurred period prior to the valuation date (this may or may not be a per exposure IBNP claim lag amount.) The total amount of reserve liabilities for IBNP claims is then estimated by summing the estimated amount of reserve liabilities for IBNP claims per incurred period over all incurred periods.

When the IBNP claim lag amount is a per exposure IBNP claim lag amount, the per exposure IBNP claim liability estimates (i.e., C\hat{ }_{l,i}, if Step 800 employed; else, C*_{l,i}, from Step 700) are summed by incurred period, then multiplied by the number of member-exposures in each incurred period prior to the valuation date to generate total estimates of IBNP claim liabilities by incurred period. For simplicity, the notation C\hat{ }_{l,i}, is employed following. However, if step 800 is not employed, the reader will substitute the notation C*_{l,i} for C\hat{ }_{l,i} in the following.

For any given month i of claims incurred the total estimated per exposure IBNP claim amount is obtained by summing the estimated per exposure IBNP claim amounts for each lag time l, for all cells where l+i>N:

$$Total per exposure IBNP in month i = {\sum }_{l > N - i} {C}_{l , i}^{\hat{}}$$

The total IBNP claims estimates for each month i is obtained by multiplying the per exposure IBNP estimate for month i by the number of members covered in month i (exposure):

$$Total IBNP in month i = {\sum }_{l > N - i} {C}_{l , i}^{\hat{}} \times {M}_{i}$$

The estimate of total IBNP claim liability or reserve for all months as of the end of month N is simply the sum for all months i:

$$Total IBNP = {\sum }_{i} [ {\sum }_{l > N - i} {C}_{l , i}^{\hat{}} \times {M}_{i} ]$$

The per month and total IBNP estimated value may be output (along with all other calculations from the above steps) as results 920 and stored in memory 900 (e.g., a database; see FIG. 2) in the computer system. The results 920 may be output from the memory 900 as outputs 940 in the form of spreadsheets, reports and the like and used to optimally allocate resources so as to minimize liability reserve margins, reduce capital expenditures and more accurately comply with GAAP and statutory reporting requirements in financial statements. End users 950, including actuaries, accountants, financial managers and the like, may further query 960 the results 920 as stored in memory 900 to provide output customized to their needs.

### DETAILED DESCRIPTION—SYSTEM

A general-purpose computer, its component devices, and software, provide means for implementing the method steps described above (see FIGS. 2 and 3). Together, these comprise the system of the present invention.

In a Projected Paid Lag module 1000, steps of the Paid Lag Method (i.e., steps 100-900 inclusive if Regressed projected paid lag version of method is employed, or steps 100-500, 700-900 if Simple Paid Lag version of method is employed) are performed in conjunction with Projected Paid Lag software 1400 (coded for one or, more generally, both versions of the method) and a data processor 1600. The module 1000 received inputs 120 of historic raw data from memory 900.

The Projected Paid Lag software 1400 is computer-readable code residing on a program storage device 1300 having a computer usable medium 1500 for storing the program code of Projected Paid Lag software 1400. The program storage device 1300 may be of a conventional variety, such as a conventional disk or memory device. The computer-usable medium 1500 on which the software 1400 is stored may be of a variety of types including, but not limited to, RAM, floppy disk, magnetic tape, CD-ROM, or other type of computer readable storage media.

The Projected Paid Lag software 1400 may be created using general-purpose application development tools such as programming languages, graphical design tools, and commercially available reusable software components. General memory 900, such as a database engine, may be used to manage data storage and retrieval.

The processor 1600 is part of a general-purpose computer system. Any general-purpose computer may be used, provided that the processing power is sufficient to achieve the desired speed of computation for the amount of data being processed by the system.

Once the estimated IBNP reserve amounts results 920 are generated and stored in memory 900, they may be used by an end user 950 in deciding how to optimally allocate resources so as to minimize liability reserve margins, reduce capital expenditures, more accurately comply with GAAP and statutory reporting requirements in financial statements, and the like. The per month and total IBNP estimated values may be output from memory 900 in the form of spreadsheets, reports and the like. End users 950, such as actuaries, accountants, financial managers and the like, may request specific information from the system through a query 960 and thereby produce output 940 customized to their needs.

The system accommodates post-processing of the results data 920, allowing delivery in various formats and through various electronic media. The system can generate output 940 in the form of further analyses and presentation as graphs, spreadsheets, maps, HTML documents, or other formats. Because of the regional geographic nature of the output, it may be suited to a geographic presentation using mapping software. As mentioned above, queries 960 may be formulated to a user's specifications in order to create customized output to use in making financial management decisions. The output 960 can be delivered electronically through a variety of channels, including facsimile, e-mail, local area networks (LANs), wide area networks (WANs) and the worldwide web. It can also, of course, be provided in hard copy.

The results 920 as stored in memory 900 themselves, or customized output data 960, may be incorporated into a company's information management system for intra-net online access (via a LAN or WAN) to enable company-wide access to results. In this way, the system of the present invention may be fully incorporated into a company's information system to provide a seamless interface to their current management decision-making structure.

### ADVANTAGE OF THE INVENTION

The accurate estimates of IBNP claim amounts produced by the previously described versions of the present invention provide several advantages to users including (a) means by which IBNP claim amounts for claims incurred in a given incurred period before a valuation date and to be paid a given lag time later in a given paid period following the valuation date, are projected be setting same equal to the average paid lag claim amount for the given lag time; (b) means by which total liability reserve amount for IBNP claims may be accurately estimated with minimal variance from the actual IBNP amount eventually paid by a payer; and (c) means for outputting the IBNP claim amount estimates for use to minimize liability reserve error with the resulting advantages of reduction of capital expenditures, accurate assessment of profitability and tax liabilities, maintenance of statutorily required minimum reserve amounts, compliance with GAAP and statutory reporting requirements in financial statements, and the like.

The present invention does not require that all the advantageous features and all the advantages need to be incorporated into every embodiment thereof.

The following example illustrates the various embodiments of the present invention. Those skilled in the art will recognize many variations that are within the spirit of the present invention and scope of the claims. Tables A-1 through A-6 provide the results of the manipulation of date via the methods of the invention as described above. In particular these tables clarify the procedure by which the dependent and independent variables in the regression analysis are identified.

TABLE A-1
Incurred and Paid Claims Data Arranged by Month Incurred (Columns) and Calendar Month Paid (Rows)

| Claims | Claims Incurred Month | | | | | | | | |
|---|---|---|---|---|---|---|---|---|---|
| Paid | July | August | September | October | November | December | January | February | March |
| Month | 2001 | 2001 | 2001 | 2001 | 2001 | 2001 | 2002 | 2002 | 2002 |
| July 2001 | 7,409 | | | | | | | | |
| August 2001 | 142,074 | 3,777 | | | | | | | |
| September 2001 | 236,520 | 123,004 | 1,948 | | | | | | |
| October 2001 | 243,382 | 329,980 | 192,909 | 5,215 | | | | | |
| November 2001 | 89,896 | 173,784 | 238,082 | 129,939 | 2,364 | | | | |
| December 2001 | 72,106 | 83,083 | 110,740 | 238,156 | 110,721 | 1,030 | | | |
| January 2002 | 38,879 | 77,029 | 121,423 | 223,193 | 199,949 | 101,780 | 5,069 | | |
| February 2002 | 33,873 | 71,747 | 97,297 | 181,353 | 216,080 | 188,706 | 248,651 | 12,777 | |
| March 2002 | 44,945 | 43,623 | 47,670 | 84,237 | 96,799 | 132,818 | 344,917 | 184,087 | 6,958 |
| April 2002 | 24,557 | 38,050 | 52,193 | 78,132 | 106,333 | 130,454 | 441,453 | 456,857 | 269,522 |
| May 2002 | 27,007 | 40,418 | 28,338 | 50,052 | 47,785 | 62,707 | 240,990 | 346,393 | 528,828 |
| June 2002 | 17,470 | 21,993 | 36,029 | 35,084 | 38,243 | 67,048 | 121,361 | 155,157 | 303,025 |
| July 2002 | 11,514 | 7,714 | 9,103 | 18,205 | 19,841 | 31,948 | 88,079 | 97,547 | 177,161 |
| August 2002 | −7,728 | 2,951 | 10,046 | 1,676 | 17,203 | 23,187 | 72,220 | 54,993 | 77,566 |
| September 2002 | 6,865 | 3,784 | 16,233 | 29,790 | 13,130 | 17,324 | 54,409 | 56,587 | 63,390 |
| October 2002 | 5,495 | −4,266 | 7,475 | 7,168 | −115 | −9,431 | 76,936 | 55,792 | 7,679 |
| November 2002 | 5,635 | 4,184 | 5,795 | 6,458 | 20,047 | 21,684 | 62,616 | 53,191 | 52,094 |
| December 2002 | 686 | 2,916 | 5,208 | 2,515 | 938 | 7,267 | 34,675 | 51,535 | 62,318 |
| Exposures | 11,339 | 11,394 | 11,422 | 11,201 | 11,251 | 11,309 | 19,879 | 19,970 | 20,058 |

| Claims | Claims Incurred Month | | | | | | | | |
|---|---|---|---|---|---|---|---|---|---|
| Paid | April | May | June | July | August | September | October | November | December |
| Month | 2002 | 2002 | 2002 | 2002 | 2002 | 2002 | 2002 | 2002 | 2002 |
| July 2001 | | | | | | | | | |
| August 2001 | | | | | | | | | |
| September 2001 | | | | | | | | | |
| October 2001 | | | | | | | | | |
| November 2001 | | | | | | | | | |
| December 2001 | | | | | | | | | |
| January 2002 | | | | | | | | | |
| February 2002 | | | | | | | | | |
| March 2002 | | | | | | | | | |
| April 2002 | 12,856 | | | | | | | | |
| May 2002 | 301,617 | 16,151 | | | | | | | |
| June 2002 | 562,113 | 392,258 | 4,657 | | | | | | |
| July 2002 | 306,748 | 702,048 | 353,601 | 14,658 | | | | | |
| August 2002 | 141,312 | 274,550 | 507,674 | 316,639 | 3,226 | | | | |
| September 2002 | 132,033 | 169,291 | 327,747 | 603,483 | 331,905 | 12,632 | | | |
| October 2002 | 61,223 | 74,562 | 110,212 | 250,897 | 578,899 | 313,714 | 32,214 | | |
| November 2002 | 57,682 | 78,710 | 80,452 | 162,402 | 282,269 | 615,518 | 347,684 | 14,237 | |
| December 2002 | 38,949 | 47,691 | 67,709 | 87,287 | 136,233 | 300,099 | 694,992 | 329,779 | 9,085 |
| Exposures | 20,218 | 20,352 | 20,491 | 20,619 | 20,673 | 20,792 | 20,681 | 20,738 | 20,866 |

The values in Table A-1 are the raw data used for the estimation of IBNP claim liability reserve.
The reciprocals of exposure counts are used for weighting of the data points.

TABLE A-2
Incurred and Paid Claims Data Rearranged by Incurred Month and Paid Lag Month

| Paid | Claims Incurred Month | | | | | |
|---|---|---|---|---|---|---|
| Lag | July | August | September | October | November | December |
| Month | 2001 | 2001 | 2001 | 2001 | 2001 | 2001 |
| 0 | 7,409 | 3,777 | 1,948 | 5,215 | 2,364 | 1,030 |
| 1 | 142,074 | 123,004 | 192,909 | 129,939 | 110,721 | 101,780 |
| 2 | 236,520 | 329,980 | 238,082 | 238,156 | 199,949 | 188,706 |
| 3 | 243,382 | 173,784 | 110,740 | 223,193 | 216,080 | 132,818 |
| 4 | 89,896 | 83,083 | 121,423 | 181,353 | 96,799 | 130,454 |
| 5 | 72,106 | 77,029 | 97,297 | 84,237 | 106,333 | 62,707 |
| 6 | 38,879 | 71,747 | 47,670 | 78,132 | 47,785 | 67,048 |
| 7 | 33,873 | 43,623 | 52,193 | 50,052 | 38,243 | 31,948 |
| 8 | 44,945 | 38,050 | 28,338 | 35,084 | 19,841 | 23,187 |
| 9 | 24,557 | 40,418 | 36,029 | 18,205 | 17,203 | 17,324 |
| 10 | 27,007 | 21,993 | 9,103 | 1,676 | 13,130 | (9,431) |
| 11 | 17,470 | 7,714 | 10,046 | 29,790 | (115) | 21,684 |
| 12 | 11,514 | 2,951 | 16,233 | 7,168 | 20,047 | 7,267 |
| 13 | (7,728) | 3,784 | 7,475 | 6,458 | 938 | |
| 14 | 6,865 | (4,266) | 5,795 | 2,515 | | |
| 15 | 5,495 | 4,184 | 5,208 | | | |
| 16 | 5,635 | 2,916 | | | | |
| 17 | 686 | | | | | |
| Exposures | 11,339 | 11,394 | 11,422 | 11,201 | 11,251 | 11,309 |
| Weight × 1000 | 0.08819 | 0.08777 | 0.08755 | 0.08928 | 0.08888 | 0.08843 |
| Paid | Claims Incurred Month | | | | | |
| Lag | January | February | March | April | May | June |
| Month | 2002 | 2002 | 2002 | 2002 | 2002 | 2002 |
| 0 | 5,069 | 12,777 | 6,958 | 12,856 | 16,151 | 4,657 |
| 1 | 248,651 | 184,087 | 269,522 | 301,617 | 392,258 | 353,601 |
| 2 | 344,917 | 456,857 | 528,828 | 562,113 | 702,048 | 507,674 |
| 3 | 441,453 | 346,393 | 303,025 | 306,748 | 274,550 | 327,747 |
| 4 | 240,990 | 155,157 | 177,161 | 141,312 | 169,291 | 110,212 |
| 5 | 121,361 | 97,547 | 77,566 | 132,033 | 74,562 | 80,452 |
| 6 | 88,079 | 54,993 | 63,390 | 61,223 | 78,710 | 67,709 |
| 7 | 72,220 | 56,587 | 7,679 | 57,682 | 47,691 | |
| 8 | 54,409 | 55,792 | 52,094 | 38,949 | | |
| 9 | 76,936 | 53,191 | 62,318 | | | |
| 10 | 62,616 | 51,535 | | | | |
| 11 | 34,675 | | | | | |
| 12 | | | | | | |
| 13 | | | | | | |
| 14 | | | | | | |
| 15 | | | | | | |
| 16 | | | | | | |
| 17 | | | | | | |
| Exposures | 19,879 | 19,970 | 20,058 | 20,218 | 20,352 | 20,491 |
| Weight × 1000 | 0.05030 | 0.05008 | 0.04986 | 0.04946 | 0.04914 | 0.04880 |
| Paid | Claims Incurred Month | | | | | |
| Lag | July | August | September | October | November | December |
| Month | 2002 | 2002 | 2002 | 2002 | 2002 | 2002 |
| 0 | 14,658 | 3,226 | 12,632 | 32,214 | 14,237 | 9,085 |
| 1 | 316,639 | 331,905 | 313,714 | 347,684 | 329,779 | |
| 2 | 603,483 | 578,899 | 615,518 | 694,992 | | |
| 3 | 250,897 | 282,269 | 300,099 | | | |
| 4 | 162,402 | 136,233 | | | | |
| 5 | 87,287 | | | | | |
| 6 | | | | | | |
| 7 | | | | | | |
| 8 | | | | | | |
| 9 | | | | | | |
| 10 | | | | | | |
| 11 | | | | | | |
| 12 | | | | | | |
| 13 | | | | | | |
| 14 | | | | | | |
| 15 | | | | | | |
| 16 | | | | | | |
| 17 | | | | | | |
| Exposures | 20,619 | 20,673 | 20,792 | 20,681 | 20,738 | 20,866 |
| Weight × 1000 | 0.04850 | 0.04837 | 0.04810 | 0.04835 | 0.04822 | 0.04792 |

Table A-2 shows the same data as in Table A-1, but rearranged by Paid Lag Month to facilitate calculation of IBNP Claim Liability estimates.

TABLE A-3
Per Exposure Paid Claim Lag Amounts

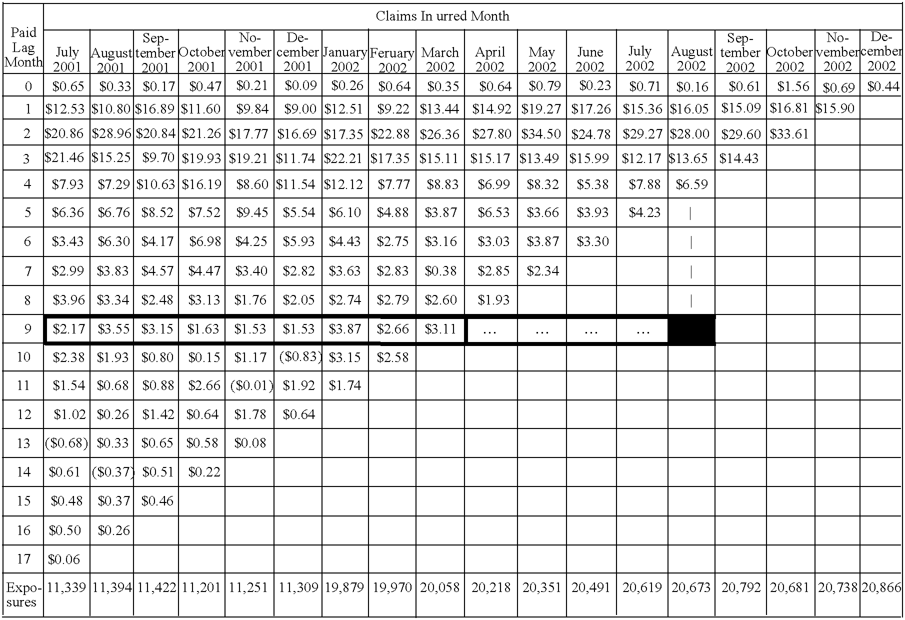

The values in Table A-3 are the amounts from Table A-2 weighted by the reciprocals of the exposure counts for each incurral month.
The values in each row (Lag Month) serve as the dependent variables for a subsequent bivariate linear regression.
For example, the data cells in the heavy boxed row (Paid Lag Month 9) will be used to estimate regression parameters for claims incurred in the fifth month prior to the valuation date, expected to be paid in the fifth month following the valuation date.

TABLE A-4
Cumulative per Exposure Paid Claim Lag Amounts

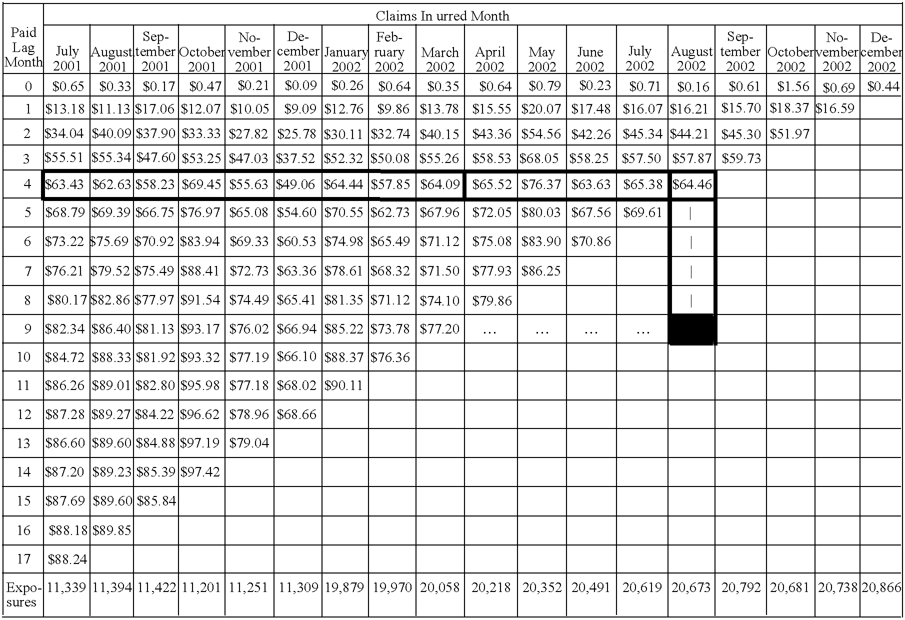

The amounts in each row of Table 4 are calculated by summing the values in the corresponding paid lag period and all previous paid lag periods for the respective claims incurral months.
The values in each row serve as the independent variable in a subsequent bivariate linear regression.
For example, the data cells in the heavy boxed row (Paid Lag Month 4) will be used to estimate regression parameters for claims incurred in the fifth month prior to the valuation date, expected to be paid in the fifth month following the valuation date.

TABLE A-5a
Regression Intercept Parameters, α, Calculated from Values in Tables A-3 and A-4 ($)

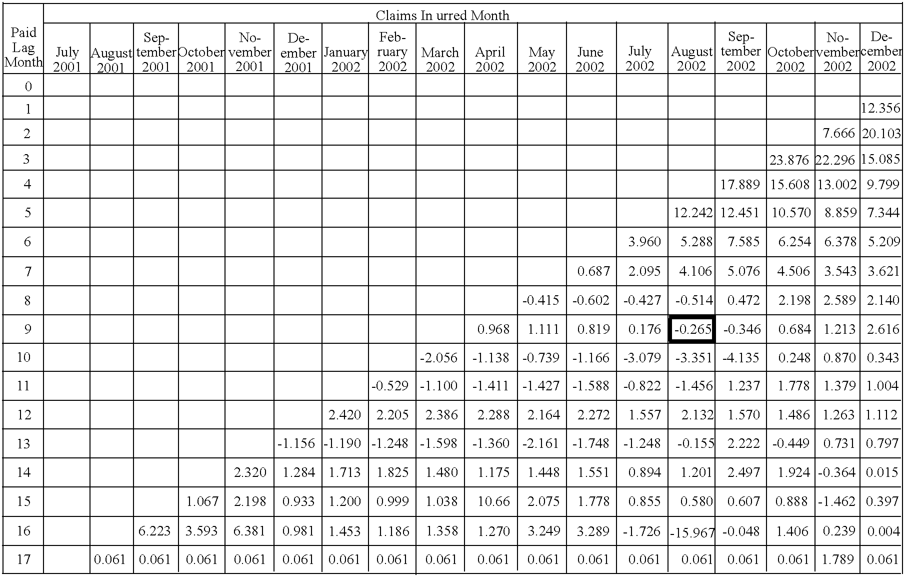

The values in Table A-5a represent the Regression Intercept parameter estimates from the regression of the corresponding Paid Lag Claim amounts in Table A-3 (dependent variables) against the Cumulative Paid Lag Claim amounts in Table A-4 (independent variables) for a linear regression of the form Y = α + βX.
The value in the heavy-boxed cell (−0.265) is the intercept parameter estimate from the regression of the corresponding heavy-boxed rows in tables A-3 and A-4, respectively.
In the final row (Paid Lag Month 17), regression is not possible since there is only one data point available.
In that case, the assumed relationship is that the projected paid lag amount for Paid Lag Month 17 is equal to the single value ($0.061 per exposure).
This is equivalent to setting the regression intercept parameter, α, equal to 0.06 1, and the slope regression parameter, β, equal to zero.

TABLE A-5b
Regression Slope Parameters, β, Calculated from Values in Tables A-3 and A-4

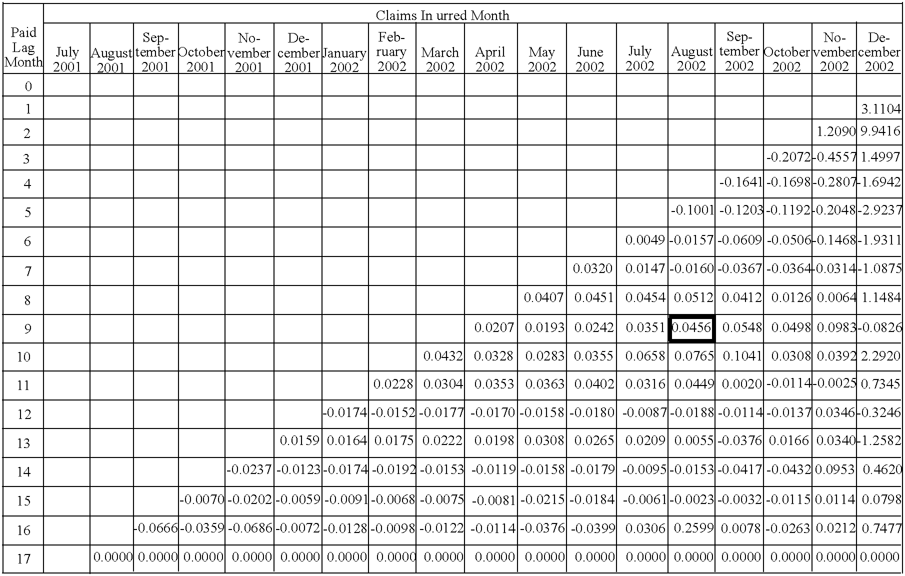

The values in Table A-5a represent the Regression Slope parameter estimates from the regression of the corresponding Paid Lag Claim amounts in Table A-3 (dependent variables) against the Cumulative Paid Lag Claim amounts in Table A-4 (independent variables) for a linear regression of the form Y = α + βX.
The value in the heavy-boxed cell (0.0456) is the slope parameter estimate from the regression of the corresponding heavy-boxed rows in tables A-3 and A-4, respectively.
As noted for Table A-5a, the slope regression parameter for Paid Lag Month 17 is set equal to zero.

TABLE A-6
Regression Estimates of per Exposure IBNP Claim Liability Amounts

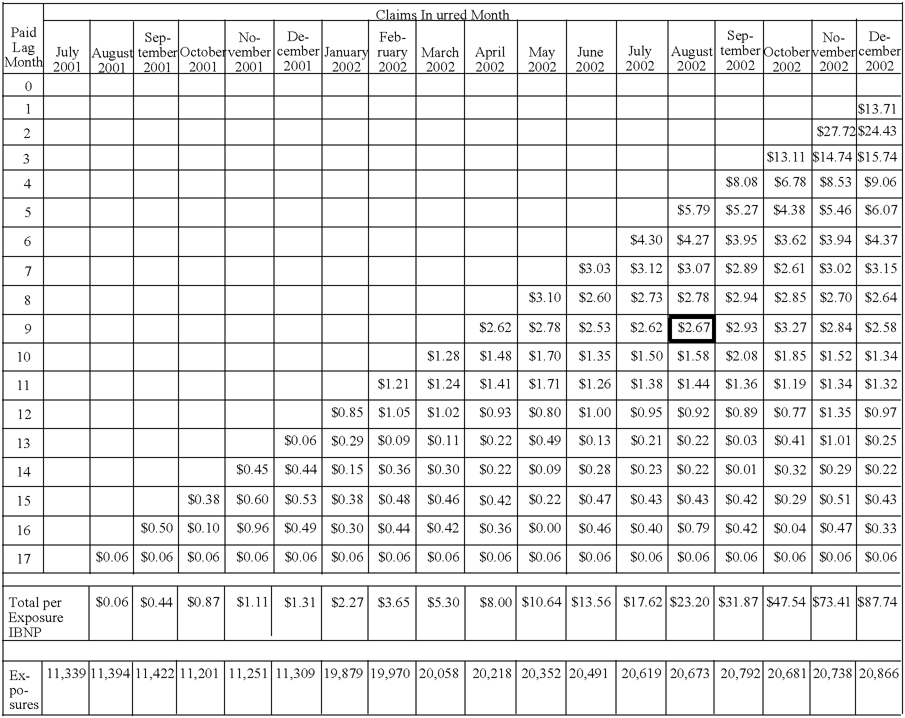

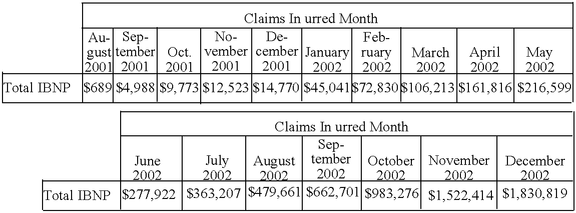

The values in Table A-6 represent the estimates of per exposure IBNP claim liability amounts calculated by applying the regression parameters shown in Tables A-5a and A-5b against the cumulative incurred and paid claim amounts for the respective incurred periods shown in Table A-4.
The value in the heavy-boxed cell is calculated from the corresponding values in Table A-4, Table A-5a, and Table A-5b: −$0.265 + 0.0456 * $64.46 = $2.67.
The Total IBNP for each of the respective incurred months can then be calculated by summing the per exposure claim lag amounts for each paid lag month then dividing by the weight factor for that month (i.e., multiplying by the number of exposures), or, equivalently, by dividing each of the respective paid lag claim amounts by the weighting factor before summing the products by incurred month.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A method for estimating incurred but not yet paid (IBNP) claim amounts, the method comprising:
a) accessing a set of historical data for each of a plurality of incurred periods and paid periods prior to a valuation date, an incurred period being a time period in which a claim is incurred and a paid period being a time period in which the incurred claim is paid, the set of historical data comprising a paid lag claim amount for each combination of incurred and paid periods, the paid lag claim amount being a total actual amount of claims incurred in a given incurred period and paid a given lag time later in a given paid period, the lag time being a measure of elapsed time from a point in the given incurred period to the given paid period;
b) identifying a functional relationship between cumulative paid lag claim amounts and paid lag claim amounts, wherein the functional relationship has one or more adjustable parameters, the cumulative paid lag claim amounts are independent variables with a cumulative paid lag claim amount for a selected incurred period being the sum of paid lag claim amounts for one or more paid periods or the sum of paid lag claim amounts for one or more paid periods multiplied by a weighting factor, and the paid lag claim amounts are dependent variables;
c) adjusting the one or more adjustable parameters to obtain optimized parameters such that a predetermined function of differences between calculated paid lag claim amounts and actual paid lag claim amounts is minimized; and
d) estimating IBNP claim amounts for each combination of incurred periods and paid periods after the valuation date, the estimated IBNP claim amounts being a projected paid claim amount calculated from the functional relationship with the optimized parameters of step c), for each paid period after the valuation date, from the cumulative paid lag claim amounts for each incurred period as of the valuation date.

2. The method of claim 1 further comprising:
e) calculating an incurred period IBNP claim amount for each incurred period by summing IBNP claim amounts estimated in step d over all paid periods after the valuation date for each incurred period before the valuation date.

3. The method of claim 2, further comprising estimating a total IBNP liability reserve amount as of the valuation date by summing the incurred period IBNP claim amounts over all incurred periods prior to the valuation date.

4. The method of claim 1 further comprising
f) calculating a paid period IBNP claim amount for each paid period after the valuation date by summing IBNP claim amounts estimated in step d over all incurred periods before the valuation date for each paid period after the valuation date.

5. The method of claim 4, further comprising estimating a total IBNP liability reserve amount by summing the paid period IBNP claim amounts over all paid periods after the valuation date.

6. The method of claim 1 wherein each of the plurality of incurred periods has an associated number of exposures and the weighting factor in step b for each of the plurality of incurred periods is 1 divided by the associated number of exposures, thereby producing per exposure paid lag claim amounts, the cumulative paid lag claim amounts are the per exposure cumulative paid lag claim amounts, and the IBNP claim amounts are the per exposure IBNP claim amounts.

7. The method of claim 6 further comprising
g) calculating an incurred period IBNP claim amount for each incurred period by summing, over all paid periods after the valuation date, the products of the per exposure IBNP claim amount for the given paid period times the number of exposures for that incurred period.

8. The method of claim 7, further comprising estimating a total IBNP liability reserve amount by summing the incurred period IBNP claim amount over all incurred periods.

9. The method of claim 6 further comprising
h) calculating a paid period IBNP claim amount for each paid period after the valuation date by summing, over all incurred periods before the valuation date for the respective paid periods, the products of the per exposure IBNP claim amount for the given paid period times the number of exposures for the respective incurred periods.

10. The method of claim 9, further comprising estimating a total IBNP liability reserve amount by summing the paid period IBNP claim amounts over all paid periods.

11. The method of claim 1 wherein step c is performed by a least squares regression.

12. A computer system executing the method of claim 1.

13. The method of claim 1, further comprising adjusting the paid lag claim amount for an effect of trend or seasonality.

14. The method of claim 13, further comprising adjusting the projected lag claim amount for an effect of trend or seasonality.

15. A method for estimating incurred but not yet paid (IBNP) claim amounts, the method comprising:
a) accessing a set of historical data for each of a plurality of incurred periods and paid periods prior to a valuation date, an incurred period being a time period in which a claim is incurred and a paid period being a time period in which the incurred claim is paid, the set of historical data comprising a paid lag claim amount for each combination of incurred and paid periods, the paid lag claim amount being a total actual amount of claims incurred in a given incurred period and paid a given lag time later in a given paid period, the lag time being a measure of elapsed time from a point in the given incurred period to the given paid period;
b) calculating a summed paid lag claim amount for a selected lag time that is equal to the sum of paid lag claim amounts for incurred periods times an incurred month specific weighting factor as of the valuation date for the selected lag time, the incurred month specific weighting factor being set to a predetermined value for each incurred month;
c) calculating a summed exposure amount that is the sum of exposures for each incurred period times the incurred month specific weighting factor that is used to calculate the summed paid lag claim amount; and
d) estimating a weighted average per exposure IBNP claim amount for each lag time by dividing the summed paid lag claim amount by the summed exposure amount.

16. The method of claims 15 further comprising:
e) calculating an incurred period IBNP claim amount for each incurred period by summing IBNP claim amounts estimated in step d over all paid periods after the valuation date for each incurred period before the valuation date.

17. The method of claim 15 wherein the incurred month specific weighting factor is equal to one and the IBNP claim amounts are average per exposure paid lag claim amount.

18. The method of claim 15, further comprising estimating a total IBNP liability reserve amount by summing the incurred period IBNP claim amount over all incurred periods.

19. The method of claim 15, further comprising adjusting the paid lag claim amount for an effect of trend or seasonality.

20. The method of claim 15, further comprising adjusting the projected IBNP claim amount for an effect of trend or seasonality.

21. A computer-implemented method for estimating incurred but not yet paid (IB NP) claim amounts, the method comprising:
a) providing a computer system for executing the computer-implemented method, the computer system having computer memory for accessibly storing data and a processor for processing data;
b) accessing a set of historical data for each of a plurality of incurred periods and paid periods prior to a valuation date, an incurred period being a time period in which a claim is incurred and a paid period being a time period in which the incurred claim is paid, the set of historical data comprising a paid lag claim amount for each combination of incurred and paid periods, the paid lag claim amount being a total actual amount of claims incurred in a given incurred period and paid a given lag time later in a given paid period, the lag time being a measure of elapsed time from a point in the given incurred period to the given paid period;
c) identifying a functional relationship between cumulative paid lag claim amounts and paid lag claim amounts, wherein the functional relationship has one or more adjustable parameters, the cumulative paid lag claim amounts are independent variables and are the sum of paid lag claim amounts for one or more paid periods or the sum of paid lag claim amounts for one or more paid periods multiplied by a weighting factor, and the paid lag claim amounts are dependent variables;
d) adjusting the one or more adjustable parameters to obtain optimized parameters such that a predetermined function of differences between calculated paid lag claim amounts and actual paid lag claim amounts is minimized; and
e) estimating IBNP claim amounts for each combination of incurred periods and paid periods after the valuation date, the IBNP claim amounts being a projected paid claim amount calculated from the functional relationship with the optimized parameters of step c, for each paid period after the valuation date, from the cumulative paid lag claim amounts for each incurred period as of the valuation date.

22. The method of claim 21 further comprising:
f) calculating an incurred period IBNP claim amount for each incurred period by summing IBNP claim amounts estimated in step d over all paid periods after the valuation date for each incurred period, and storing the incurred period claim amount in the computer memory.

23. The method of claim 22, further comprising estimating a total IBNP liability reserve amount by summing the incurred period IBNP claim amount over all incurred periods and storing the total IBNP reserve amount in the computer memory.

24. The method of claim 21 further comprising
g) calculating a paid period IBNP claim amount for each paid period by summing IBNP claim amounts estimated in step d over all incurred periods after the valuation date for each paid period and storing the paid period IBNP amount in the computer memory.

25. The method of claim 24, further comprising estimating a total IBNP liability reserve amount by summing the paid period IBNP claim amounts over all paid periods.

26. The method of claim 21 wherein each of the plurality of incurred periods has an associated number of exposures and the weighting factor in step b for each of the plurality of incurred periods is 1 divided by the associated number of exposures, the cumulative paid lag claim amounts are the per exposure cumulative paid lag claim amounts, the paid lag claim amounts are the per exposure paid lag claim amounts, and the IBNP claim amounts are the per exposure IBNP claim amounts.

27. The method of claim 26 further comprising
h) calculating an incurred period IBNP claim amount for each incurred period by summing, over all paid periods after the valuation date, the productsof the per exposure IBNP claim amount for the given paid period times the number of exposures for that incurred period.

28. The method of claim 27, further comprising estimating a total IBNP liability reserve amount by summing the incurred period IBNP claim amount over all incurred periods.

29. The method of claim 26 further comprising
i) calculating a paid period IBNP claim amount for each paid period after the valuation date by summing, over all incurred periods before the valuation date for the respective paid periods, the products of the per exposure IBNP claim amount for the given paid period times the number of exposures for the respective incurred periods.

30. The method of claim 29, further comprising estimating a total IBNP liability reserve amount by summing the paid period IBNP claim amounts over all paid periods.

31. The method of claim 21 wherein step c is performed by a least squares regression.

32. A computer system executing the method of claim 21.

33. The method of claim 21, further comprising adjusting the paid lag claim amount for an effect of trend or seasonality.

34. The method of claim 21, further comprising adjusting the projected IBNP claim amount for an effect of trend or seasonality.
